(19) United States
(12) Patent Application Publication
(10) Pub. No.: US 2025/0128238 A1
(43) Pub. Date: Apr. 24, 2025

(54) SEPARATION MEDIA CONTAINING DYES

(71) Applicant: Donaldson Company, Inc., Bloomington, MN (US)

(72) Inventor: Graham Temples, Greenville, SC (US)

(21) Appl. No.: 18/925,985

(22) Filed: Oct. 24, 2024

Related U.S. Application Data
(60) Provisional application No. 63/545,526, filed on Oct. 24, 2023.

(51) Int. Cl. B01J 20/32; B01D 15/20; B01D 15/38; B01D 15/42; B01J 20/22; B01J 20/28; B01J 20/289

(52) U.S. Cl. CPC B01J 20/3219; B01D 15/20; B01D 15/3823; B01D 15/424; B01J 20/22; B01J 20/28033; B01J 20/289; B01J 20/3208; B01J 20/3251

(57) ABSTRACT

Separation media containing dyes is disclosed. Separation media includes a support substrate and a plurality of separation ligands immobilized on the support substrate. The plurality of separation ligands include an affinity group capable including a dye. The affinity group is capable of binding a biomolecule. Methods of making the separation media and methods of using the separation media are disclosed.

### CROSS-REFERENCE TO RELATED APPLICATION

This application claims the benefit of U.S. Provisional Patent Application No. 63/545,526, filed Oct. 24, 2023, which is incorporated herein by reference in its entirety.

### FIELD

The present disclosure relates to separation media and separation devices containing the same. The separation media of the present disclosure include a dye. The separation media of the present disclosure may be useful for isolation and/or concentration of biomolecules (e.g., proteins or fragments thereof) that include are capable of binding a dye. The separation media of the present disclosure may be used for separations in membrane chromatography. The present disclosure further relates to methods of making and using the separation media.

### BACKGROUND

Prior to downstream use, many biomolecules are isolated, purified, and/or concentrated. For example, proteins that may be used for research purposes are as therapeutics are often isolated from impurities of expression systems used to produce them. Additionally, oligonucleotides are often isolated from byproducts of in vitro or in vivo production systems. Traditional protein and oligonucleotide purification methods are often slow and costly. For example, some traditional purification methods use columns packed with expensive specialized resin. Additionally, some traditional purification methods require slow flow rates. Due at least in part to the specialized resin and/or slow flow rate, some traditional purification methods are difficult to scale.

### SUMMARY

This disclosure describes, in one aspect, a separation media that includes a support substrate and a plurality of separation ligands immobilized on the support substrate. The plurality of separation ligands are of the formula SL:

-L-Z (SL)
where L is a linker and Z is a separation group. The separation group includes an affinity group. The affinity group includes a dye capable of binding a biomolecule. In some embodiments, the formula SL is of formula SL1 or SL2

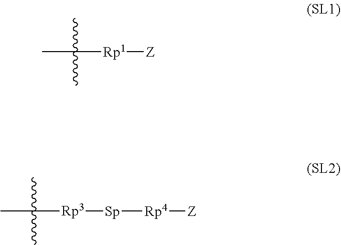

In formula SL1 and SL2 Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, or an isomer thereof

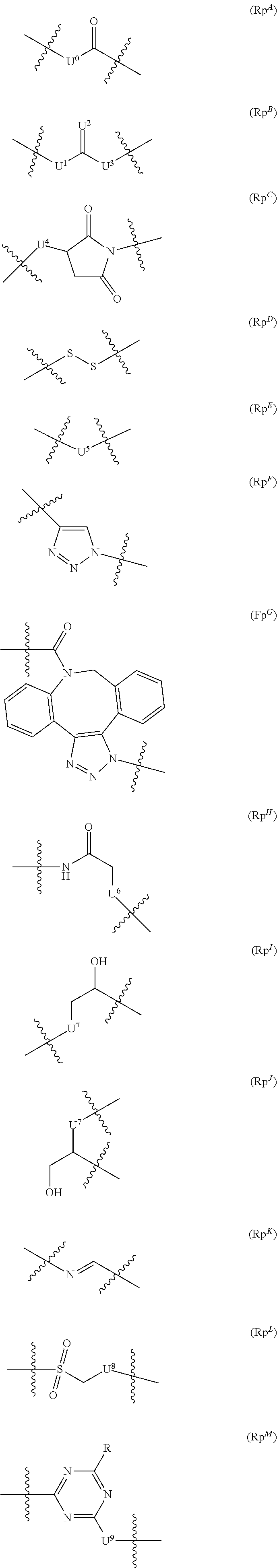

where U⁰, U¹, U², U³, U⁴, U⁵, U⁶, and U⁷ are each independently NH, N, O, or S and Sp is a spacer.

In another aspect, this disclosure describes a separation device that includes a housing and a separation media of the present disclosure disposed within the housing.

In another aspect, this disclosure describes a method for isolating a target molecule from an isolation solution. The isolation solution includes an isolation solvent and the target molecule. The target molecule includes a biomolecule. The method includes contacting the isolation solution with the separation media or separation device of the present disclosure.

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The following detailed description of illustrative embodiments of the present disclosure may be best understood when read in conjunction with the following drawings.

FIG. 1A is a flow diagram of a first method for making the separation media of the present disclosure.

FIG. 1B is a flow diagram of a second method for making the separation media of the present disclosure.

FIG. 2A is a flow diagram of a third method for making the separation media of the present disclosure.

FIG. 2B is a flow diagram of a fourth method for making the separation media of the present disclosure.

FIG. 3A is a flow diagram of a fifth method for making the separation media of the present disclosure.

FIG. 3B is a flow diagram of a sixth method for making the separation media of the present disclosure.

FIG. 4A is a schematic of a separation media consistent with embodiments of the present disclosure.

FIG. 4B is a schematic representation of a separation device consistent with embodiments of the present disclosure.

FIG. 5 is a flow diagram of a method of using the separation media and/or separation devices of the present disclosure.

FIG. 6 is a first schematic synthetic strategy for the making of separation media consistent with the present disclosure. This strategy includes the deposition of a polymer onto the support substrate through the grafting on technique. This strategy also includes indirect immobilization of the separation ligands onto the support substrate and an amine assisted coupling method.

FIG. 7 is a second schematic synthetic strategy for the making of separation media consistent with the present disclosure. This strategy includes the deposition of a polymer onto the support substrate through the grafting from technique. This strategy also includes indirect immobilization of the separation ligands onto the support substrate and an amine assisted coupling method.

FIG. 8 is a third schematic synthetic strategy for the making of separation media consistent with the present disclosure. This strategy includes direct immobilization of the separation ligands onto the support substrate and an amine assisted conjugation method.

FIG. 9 is a fourth schematic synthetic strategy for the making of separation media consistent with the present disclosure. This strategy includes direct immobilization of the separation ligands onto the support substrate and an organic solvent assistance conjugation method.

The schematic drawings are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### Definitions

All scientific and technical terms used herein have meanings commonly used in the art unless otherwise specified. The definitions provided herein are to facilitate understanding of certain terms used frequently herein and are not meant to limit the scope of the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used herein, the symbol

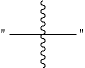

(hereinafter can be referred to as “a point of attachment bond”) denotes a bond that is a point of attachment between two chemical entities, or a chemical entity and a support substrate, one of which is depicted as being attached to the point of attachment bond and the other of which is not depicted as being attached to the point of attachment bond. For example,

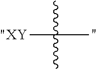

indicates that the chemical entity “XY” is bonded to another chemical entity or a support substrate via the point of attachment bond.

The term “organic group” refers to a group that has carbon-hydrogen bonds. The group may also include heteroatoms such as O, S, N, or P. One or more heteroatoms may be catenated at any location in the organic group (e.g., ether, thioether, or amine). A heteroatom may be covalently bonded to a carbon atom through a double bond (e.g., ketone, imine). A heteroatom covalently bonded to a carbon atom may also be covalently bonded to another heteroatom (e.g., phosphodiester, sulfone). One or more functional groups may be included in an organic group, for example, alkane (branched, linear, cyclic, or any combination thereof), alkene (branched, linear, cyclic, or any combination thereof), alkyne (branched, linear, cyclic, or any combination thereof), aromatic, amine (primary, secondary, tertiary, or quaternary), amino, amide, alcohol (primary, secondary, or tertiary), alkoxy, aldehyde, carboxylic acid, ether, ester, imine, phosphoester, phosphodiester, sulfone, sulfonamide, urea, thiourea, thioether, or any combination thereof, and ionized versions thereof. Generally, the organic group may be covalently bonded to a compound. The point of attachment of the organic group to the compound may be described in several ways. For example, in some embodiments, the organic group may be described as the monovalent or radical of the respective functional group (e.g., alkyl for alkane, aryl for aromatic ring, aminyl for a primary or secondary amine). In some embodiments, where a general formula is shown with a covalent bond connecting the organic group to a compound, the organic group may be described as the common functional group. For example, if the organic group R is described relative to the formula CH₃CH₂CH₂—R, the organic group may be described, for example, as an aromatic ring.

The term “catenated” in the context of heteroatoms refers to a heteroatom (e.g., O, S, N, P) that replaces at least one carbon atom in a carbon chain. For example, ether groups contain one catenary oxygen atom with at least one carbon atom on each side of the catenary oxygen atom and polyether groups contain more than one catenary oxygen atom with carbon atoms on each side of the more than one catenary oxygen atoms.

The term “aryl” refers to a monovalent group that is aromatic. The aryl group may be carbocyclic or include one or more heteroatoms such as S, N, or O. Example aryl groups include, but are not limited to, phenyl, thiophenyl, furanyl, pyridinyl, pyrimidinyl, piperidinyl, and pyrrolyl.

The term “alkanediyl” refers to a divalent group that is a radical of an alkane and includes groups that are linear, branched, cyclic, bicyclic, or a combination thereof. Unless otherwise indicated, the alkanediyl group typically has 1 to 30 carbon atoms. In some embodiments, the alkanediyl group has 1 to 20 carbon atoms, 1 to 10 carbon atoms, 1 to 6 carbon atoms, or 1 to 4 carbon atoms. Examples of “alkanediyl” groups include methylene, ethylene, propylene, 1,4-butylene, 1,4-cyclohexylene, and 1,4-cyclohexyldimethylene.

“Alkenyl” or “alkenyl group” refers to a straight or branched hydrocarbon chain radical having from two to forty carbon atoms, and having one or more carbon-carbon double bonds. Each alkenyl group is attached to the rest of the molecule by a single bond. Unless stated otherwise specifically in the specification, an alkenyl group can be optionally substituted.

“Alkoxy” refers to the group-OR, where R is alkyl, alkenyl, alkynyl, cycloalkyl, or heterocycle as defined herein. Unless stated otherwise specifically in the specification, alkoxy can be optionally substituted.

The term “backbone” refers to the longest contiguous chain. One or more branches may be covalently bonded to the backbone.

The term “aromatic” refers to a cyclic, fully conjugated planar structure that obeys Hückel's rules, that is the compound has 4n+2pi electrons where n is a positive integer or zero. For example, benzene has 6 π electrons. Thus, 6=4n+2pi. Solving for n gives 1. Therefore, benzene is an aromatic compound.

The term “kosmotrope” is generally used to denote a solute that increases the degree of ordered-ness of water by stabilizing water-water interactions. Kosmotropes may be ionic or non-ionic. In contrast, the term “chaotrope” is generally used to denote a solute that decreases the degree of ordered-ness of water by destabilizing water-water interactions. Chaotropes may be ionic or non-ionic.

The term “peptide” refers to a sequence of amino acid residues without regard to the length of the sequence. Therefore, the term “peptide” refers to any amino acid sequence having at least two amino acids and includes full-length proteins and, as the case may be, polyproteins.

The term “polypeptide” refers to a sequence of amino acid residues without regard to the length of the sequence. Therefore, the term “polypeptide” refers to any amino acid sequence having at least two amino acids and includes full-length proteins, fragments thereof, and/or, as the case may be, polyproteins.

The term “protein” refers to any sequence of two or more amino acid residues without regard to the length of the sequence, as well as any complex of two or more separately translated amino acid sequences. Protein also refers to amino acid sequences chemically modified to include a carbohydrate, a lipid, a nucleotide sequence, or any combination of carbohydrates, lipids, and/or nucleotide sequences. As used herein, “protein,” “peptide,” and “polypeptide” are used interchangeably.

The term “nucleic acid” and/or “oligonucleotide” are used interchangeably to refer to a polymer containing at least two nucleotides (e.g., deoxyribonucleotides or ribonucleotides) in either single- or double-stranded form and includes DNA and RNA. “Nucleotides” include a sugar, a base, and a linking group. Nucleotides are linked together through the linking group to form oligonucleotides. A polymer of covalently bonded linking groups may be termed a backbone. In natural DNA and/or RNA oligonucleotides, the linking group is a phosphate, and two adjacent nucleotides are linked through a phosphodiester bond. Oligonucleotides may include natural nucleobases; modified nucleobases; natural sugars; modified sugars; natural linking groups; modified linking groups; or any combination thereof. Bases, sugars, and linking groups that are “modified” may be naturally occurring (e.g., methylated cytosine); synthetic derivatives of naturally occurring bases, sugars, or linking groups (e.g., modifications at the 2′ location of a ribose or deoxyribose; phosphorodiamidate linking groups; phosphorothioate linking groups; locked or bridged sugars to form locked or bridged nucleic acids); or replacement moieties that are not derived from natural bases, sugars, or linking groups but that can be used in place of bases, sugars, or linking groups (e.g., morpholino rings as substitutes for sugars).

In the description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

For any method disclosed herein that includes discrete steps, the steps may be performed in any feasible order. And, as appropriate, any combination of two or more steps may be performed simultaneously.

### DETAILED DESCRIPTION

The present disclosure provides separation media and separation devices containing the same. Specifically, the disclosure provides separation media that may be used to concentrate or separate (e.g., purify) a target molecule that can bind to a dye. To that end, the separation media of the present disclosure include separation ligands. The separation ligands include a separating group that can be an affinity group, an assistance group, or a capping group. The affinity group includes a dye. Multiple layers of separation media of the present disclosure may be arranged in a stacked configuration to increase separation specificity and/or efficiency. The separation media of the present disclosure may be used for separations in membrane chromatography.

The use of biomolecules as therapeutics is of increasing interest. For example, proteins, such as antibodies and antibody fragments or related proteins, are being explored to target biological targets that are implicated in disease and/or disease progression. Additionally, oligonucleotide containing therapies are being explored as a means of curing genetic diseases (e.g., through gene editing technology such as CRISPR-Cas systems) and/or preventing, inhibiting progression, and/or treating various diseases.

In some cases, oligonucleotides are delivered to the body that are then used to produce therapeutic proteins or other therapeutic oligonucleotides. For example, vectors such as viral vectors derived from viruses, and non-viral vectors are being explored to deliver various gene therapies. A viral vector is a recombinant virus that has been engineered for a specific application, such as gene therapy delivery. Examples of viral vectors include adeno-associated viral vectors, adenoviral vectors, retroviral vectors, and lentiviral vectors. Sixty-five percent of the current gene therapies under clinical trials are using viral vectors as delivery vehicles. While more than 50 different types of vectors are under investigation, 20-30% of the new gene therapy clinical trials are lentiviral vector based. However, due to lentiviral vector fragility and limited purification tools available, downstream purification of these vectors faces significant challenges at larger scale, including poor scalability, low productivity, and often a trade-off between recovery and purity.

Traditionally, downstream purification of proteins and other biomolecules (e.g., oligonucleotides) has been expensive, slow, and difficult to scale. Typical protein purification trains include various steps such as centrifugation, filtering, and one or more chromatography separations using one or more types of chromatography columns (e.g., size exclusion columns and affinity chromatography columns). A typical chromatography column used in protein purification may include a packed bed column with resin configured for size exclusion chromatography, reverse phase chromatography, or affinity chromatography. Resin based chromatography columns have been the gold standard employed to purify proteins for decades.

Typical viral vector purification methods are time-consuming with many steps and often result in low recovery. For example, to obtain high purity, a typical viral vector downstream process can require as many as nine separate purification steps, including: 1) clarification, 2) benzonase treatment, 3) ion exchange capture, 4) PEG precipitation, 5) centrifugation, 6) solvent extraction, 7) ion exchange polishing, 8) gel filtration, and 9) sterile filtration. This tedious process is costly in terms of time and capital, as well as recovery of active viral vectors. Even if every step could achieve a high recovery of 90%, the final yield after nine steps would be only 39% (0.9⁹×100%=39%). The problem of low recovery is exacerbated by the reality that high starting viral vector titers are difficult to obtain. It is further exacerbated by the fact that viral vectors, such as lentivirus based-viral vectors can lose infectivity during long processing. Additionally, viral vector purification trains often include various chromatography steps (e.g., ion exchange capture and ion exchange polishing) using one or more types of chromatography columns (e.g., size exclusion columns and affinity chromatography columns). A typical chromatography column used in viral vector purification may include a packed bed column with resin configured for size exclusion chromatography, reverse phase chromatography, or affinity chromatography.

A drawback of resin-based columns is that the binding capacity of the target molecule decreases as flow rate increases. More specifically, as the flow rate increases the column residence time of the target molecule decreases and the purification recovery of the target molecule initially loaded onto the column decreases. For example, resins displaying the affinity ligand Protein A (an immunoglobulin-binding protein) are commonly used to purify monoclonal antibodies. Protein A chromatography resins have monoclonal antibody binding capacities of 60 mg to 80 mg of the monoclonal antibody per milliliter of resin at a six minute column residence time. The capacities decrease to 18 mg to 30 mg of the monoclonal antibody per milliliter of resin at a one minute to two minute residence time.

Long residence times are used to attain high binding capacities of the target molecules due to slow mass transfer of target molecules through the small pore structures of resins. Typical resin chromatography products are configured to have a target molecule residence time of six minutes or longer to achieve optimal binding capacity. Such long residence times may result in low productivity and/or target molecule degradation.

Resin-based columns may be prone to clogging and/or fouling. Additionally, as a symptom of column clogging and/or use of a high flow rate, resin-based chromatography systems can suffer from high backpressure. Furthermore, due to the desirability of long residence times and low flow rates, large volume purification may require a large amount of resin, multiple resin columns run in sequence, and/or slow flow rates.

Membrane chromatography is an alternative to resin-based chromatography. Adsorptive membranes (membranes that do not display affinity ligands) with large flow-through pores can operate with short residence times but have low binding capacity. Existing porous hydrogel membranes often have higher binding capacities than membranes; however, their small mesh size often results in poor target macromolecule accessibility leading to decreased binding capacity at short target molecule residence times. Additionally, high backpressure (e.g., greater than 3 bar) due to increased flow rates associated with shorter target molecule residence times is an issue associated with porous hydrogel.

The present disclosure describes separation media that may be used for separation in membrane chromatography. In contrast to resin columns, membrane adsorbers perform well at short column residence times, potentially providing rapid separations for biologics such as proteins and/or oligonucleotides. The present disclosure provides separation media that are suitable for separation, purification, and/or concentration of target molecules that have affinity for and can bind to a dye.

Molecules of interest that may be separated using the separation media of the present disclosure are collectively referred to here as target molecules or as targets. A particular separation media can be chosen based on the identity of the target molecule. The target molecules of the present disclosure are proteins, glycans, and/or oligonucleotides. In some embodiments, the target molecule is a protein. In some embodiments, the target molecule is a glycosylated protein; that is, a protein that is conjugated to a monosaccharide or a polysaccharide. In some embodiments, the target molecule is a protein. In other embodiments, the target molecule is an oligonucleotide. The target oligonucleotide may be double stranded, single stranded, or have one or more regions of double stranded natura and one or more regions of single stranded nature. In some embodiments the oligonucleotide is a vector, such as a viral vector or a non-viral vector. Viral vectors include, for example, those derived from a retrovirus, an adenovirus, an adeno-associated virus, a lentivirus, or a herpes simplex virus. Non-viral vectors include plasmids.

The target molecules may be present in a solution, suspension, or dispersion. For simplicity, the liquid containing the target molecules is referred to here as an isolation solution. Also for simplicity, a target may be referred to in the singular but it is understood that an isolation solution may include a plurality of target molecules of the same identity. An isolation solution may also include two or more targets of different identity. The isolation solution may be or include a cell lysate or a solution that includes or does not include other biomolecules in addition to the target molecule. The separation media may be used to remove or separate the target molecule from other biomolecules in the isolation solution.

In some embodiments, the isolation solution includes a lysate. In other embodiments, the isolation solution includes a solution of the target molecule that does not include other biomolecules. In such embodiments, the separation media of the present disclosure may be used to concentrate the target. The isolation solution containing the target molecule may also include solvents, such as water, an organic solvent, or a combination thereof, and/or soluble components dissolved in the solvent. The separation media may be configured for use with an organic solvent. The separation media may be configured to separate the target molecules from an isolation solution that includes an organic solvent.

A separation media of the present disclosure includes a plurality of separation ligands immobilized on a support substrate. The plurality of separation ligands include one or more separation groups. A separation group is a chemical group that facilitates the isolation of a target molecule from an isolation solution. Facilitation of separation may be in the form of a chemical group to which the target molecule binds or selectively binds; a chemical group that allows for increased density of the affinity group-target molecule interaction and/or increases the target molecule attraction to a support membrane (support substrate); or a chemical group that blocks a reactive group from covalently modifying the target molecule during contact with the separation media; or any combination thereof.

A separation group may be an affinity group, an assistance group, or a capping group. The separation media includes a plurality of separation ligands that include an affinity group. In some embodiments, the plurality of separation ligands includes two or more different affinity groups. Each of the two or more affinity groups may bind to the same target molecule or different target molecules.

In addition to the plurality of separation ligands that include an affinity group, the separation media may include a plurality of separation ligands that include an assistance group; a plurality of separation ligands that include a capping group; or both.

A support substrate is the base material for the separation media. The support substrate provides a platform for which the separation ligands are immobilized. The support substrate includes at least one membrane. In some embodiments, the support substrate is the at least one membrane. In some embodiments, the support substrate includes two or more membranes arranged in a stacked configuration. In addition to the at least one membrane, the support substrate may include additional layers such as hydrogels, woven fibrous materials (i.e., a material made by the interlacing of multiple fibers), nonwoven fibrous materials (i.e., a material made from one or more fibers that are bound together through chemical, physical, heat, or mechanical treatment); or any combination thereof. Such additional layers may impart rigidity and structure to the support substrate. In some embodiments, the support substrate includes a functionalized material that is deposited on the surface of the at least one membrane. The functionalized material may provide reactive handles to which the separation ligands may be reacted to be immobilized to the support substrate. In embodiments where the separation media includes multiple layers, the layers may be laminated.

Any layer of the support substrate may be made of any suitable material. A suitable support substrate material is a material that is porous so as to allow the isolation solution to pass through the support substrate. In some embodiments, a suitable support substrate material is a material that does not chemically alter the target molecule; that is, does not react with the target molecule to add, remove, or transform chemical groups on the target molecule. Additionally, in some embodiments, a suitable support substrate is a material that does not react with the target molecule, or other molecules in the isolation solution, to form a covalent bond which would permanently immobilize said molecule to the support substrate.

The support substrate includes at least one membrane. A membrane is understood as a sheet of material with a continuous pathway of polymeric material in all dimensions. The membrane may be made of any suitable support substrate material. Examples of suitable support substrate membrane materials include polyolefins; polyethersulfone; poly(tetrafluoroethylene); nylon; fiberglass; hydrogels; polyvinyl alcohol; natural polymers such as cellulose, cellulose ester, cellulose acetate, regenerated cellulose, cellulosic nanofiber, cellulose derivatives, agarose, chitosan; polyethylene; polyester; polysulfone; expanded polytetrafluoroethylene (ePTFE), polyvinylidene fluoride; polyamide (Nylon); polyacrylonitrile; polycarbonate; and any combination thereof.

In some embodiments, the membrane itself is functionalized prior to immobilizing the separation ligands. Functionalization of the membrane may be done to install reactive handles (e.g., a support substrate reactive handle as discussed herein) on the membrane. The reactive handles react with cooperative reactive handles on the separation ligands to form a covalent bond thereby immobilizing the separation ligands on the support substrate (as discussed herein). Functionalization may be accomplished by plasma treatment, corona treatment, and the like.

In some embodiments, the support substrate includes a functionalized layer. In some embodiments, the functionalized layer is a membrane. A functionalized layer is a material disposed on the surface of a support substrate layer (e.g., disposed on the surface of the at least one membrane) and includes the support substrate reactive handles that may be used for separation ligand immobilization. A functionalized layer may be covalently attached to the support substrate; adhered to the support substrate through electrostatic forces, hydrogen-bonding, and/or Van der Waals forces; laminated to the support substrate; or simply contacting the support substrate. A functionalized layer may be deposited on the surface a support substrate (e.g., on the surface of the at least one membrane) using a variety of deposition techniques such as chemical vapor deposition, dip coating, spray coating, electrospinning, and the like.

In some embodiments, the functionalized layer is a polymer that is disposed onto the support surface using a grafting on or grafting from polymerization technique. Without wishing to be bound by theory, it is thought that disposing a polymer on the support substrate may increase the surface area and number of available support substrate reactive handles that can be used to immobilize the separation ligands and therefore result in high binding capacity of the separation media. The terms “grafting on,” “grafting onto,” and “grafted onto” refer to already formed polymer chains that adsorb or covalently attach to a surface (e.g., a support substrate surface). The terms “grafting from” or “grafted from” refer to a polymer chain that is initiated and grown from a surface (e.g., a support substrate surface). Any suitable polymer may be grafted on or grafted from a support substrate to form a functionalized layer. Suitable polymers are those that include a functional group that includes a reactive handle that allows for attachment of separation ligands to the support substrate. The reactive handle is not the polymerizable group, but instead is a group that remains intact following polymerization. Example polymers that include a reactive handle or a functional group that can be converted to a reactive handle (i.e., support substrate reactive handle) include carboxylic acids, amines, alcohols, epoxides, amides, azide, alkynes, and the like. Examples of monomers that can be used to form such polymers include vinyl alcohol, hydroxy functional acrylates (e.g., 2-hydroxyethyl acrylate and 4-hydroxybutyl acrylate), hydroxy functional methacrylate (e.g., hydroxyethyl methacrylate), epoxy containing monomers, and hydroxy functional acrylamides (e.g., N-hydroxyethyl acrylamide). Examples of specific polymers that may be grafted on or grafted from a support substrate include polydopamine, poly(vinyl alcohol), poly(acrylic acid), poly(glycidyl methacrylate, and poly 2-hydroxyethyl acrylate (formed from 2-hydroxyethyl acrylate monomers). Graft on and graft from polymerization may be accomplished using a suitable technique such as addition polymerization (e.g., free radical polymerization such as atom transfer radical polymerization (ATRP) and reversible addition fragmentation chain transfer (RAFT) polymerization; anionic polymerization; and cationic polymerization), or condensation polymerization. In some embodiments, where the polymer is grafted from the support substrate, an initiator is first coupled to the support substrate (e.g., through an OH group on the support substrate). Any suitable initiator may be used, for example, 2-bromo-2-methylpropionyl bromide (BiBB).

The membranes of the support substrate are porous and can have an average pore size, as measure by a capillary flow porometer, of 10 micrometer or less, 5 micrometers or less, 2 micrometers or less, 1 micrometer or less, 0.6 micrometers or less, 0.5 micrometers or less, 0.45 micrometers or less, or 0.2 micrometers or less. The membrane may have an average pore size of 0.1 micrometers or greater, 0.2 micrometers or greater, 0.45 micrometers or greater, 0.5 micrometers or greater, 0.6 micrometers or greater, 0.7 micrometers or greater, or 1 micrometer or greater. The membrane may have an average pore size ranging from about 0.1 micrometers to 10.0 micrometers, 0.1 micrometers to 0.2 micrometers, 0.1 micrometers to 0.45 micrometers, 0.1 micrometers to 0.5 micrometers, 0.1 micrometers to 1 micrometers, 0.2 micrometers to 0.45, 0.2 micrometers to 0.50, 0.2 micrometers to 1 micrometers, 0.2 micrometers to 2 micrometers, 0.2 micrometers to 10 micrometers, 0.45 micrometers to 1 micrometers, 0.45 micrometers to 2 micrometers, 0.45 micrometers to 10 micrometers, 1 micrometers to 2 micrometers, or 1 micrometers to 5 micrometers. In some embodiments, the support substrate has an average pore size of 0.1 micrometers to 0.5 micrometers, 0.1 micrometers to 0.6 micrometers, 0.1 micrometers to 0.3 micrometers, or 0.4 micrometers to 0.6 micrometers.

In some embodiments, the support membrane includes cellulose such as regenerated cellulose, cellulose acetate, or cellulose ester. In some such embodiments, the support membrane has an average pore size 0.1 micrometers to 0.5 micrometers, 0.1 micrometers to 0.6 micrometers, 0.1 micrometers to 0.3 micrometers, or 0.4 micrometers to 0.6 micrometers.

The membrane may have a thickness of 2500 micrometers or less, 1000 micrometers or less, 500 micrometers or less, 250 micrometers or less, or 100 micrometers or less. The thickness of the membrane may be in a range of 30 micrometers to 500 micrometers, 50 micrometers to 500 micrometers, 80 micrometers to 500 micrometers, 100 micrometers to 500 micrometers, 250 micrometers to 500 micrometers, 30 micrometers to 250 micrometers, 50 micrometers to 250 micrometers, 80 micrometers to 250 micrometers, 100 micrometers to 2500 micrometers, 30 micrometers to 100 micrometers, 50 micrometers to 100 micrometers, or 80 micrometers to 100 micrometers.

In some embodiments, the support substrate includes multiple membranes stacked in a multilayer arrangement to increase capacity or selectivity of the separation media for a given application. The multilayer membrane configuration (i.e., only considering the membrane layers of a support substrate) may have a thickens of 10,000 micrometer (micrometers) or less, 7,500 micrometers or less, 5,000 micrometers or less, 4,000 micrometers or less, 3,000 micrometers or less, 2,500 micrometers or less, 2,000 micrometers or less, 1,000 micrometers or less, 750 micrometers or less, 500 micrometers or less, 400 micrometers or less, or 300 micrometers or less. The stacked arrangement of membranes may have a thickness ranging from 70 micrometers to 10,000 micrometers, 70 micrometers to 100 micrometers, 70 micrometers to 200 micrometers, 70 micrometers to 300 micrometers, 70 micrometers to 400 micrometers, 70 micrometers to 500 micrometers, 70 micrometers to 750 micrometers, 70 micrometers to 1,000 micrometers, 70 micrometers to 2,000 micrometers, 70 micrometers to 3,000 micrometers, 70 micrometers to 4,000 micrometers, 70 micrometers to 5,000 micrometers, 250 micrometers to 300 micrometers, 250 micrometers to 400 micrometers, 250 micrometers to 500 micrometers, 250 micrometers to 750 micrometers, 250 micrometers to 1,000 micrometers, 250 to 2,000 micrometers, 250 to 3,000 micrometers, 250 to 4,000 micrometers, 250 to 5,000 micrometers, 500 micrometers to 1,000 micrometers, 500 micrometers to 2,000 micrometers, 500 micrometers to 3,000 micrometers, 500 micrometers to 4,000 micrometers, or 500 micrometers to 5,000 micrometers in thickness.

In some embodiments, the membrane is a regenerated cellulose membrane having a pore size of between 0.2 micrometers and 5.0 micrometers, a thickness of between 70 micrometers and 2,000. Such membranes may be in a stacked arrangement that is approximately 70 micrometers to 10,000 micrometers in thickness.

The support substrate may include or be a microfiltration membrane. Microfiltration membranes are typically created through a phase inversion process or an expansion process. Typical materials used to prepare membranes include polyethersulfone (PES), nylon, polyvinylidene fluoride (PVDF), cellulose acetate, regenerated cellulose, polypropylene, and expanded polytetrafluoroethylene (ePTFE).

A plurality of separation groups are immobilized on the support substrate. The separation groups include at least one affinity group. The affinity group can bind a target molecule. The affinity group is capable of selectively or non-selectively binding to a target peptide, target oligonucleotide, or both. The affinity groups of the present disclosure include a dye. A “dye” is a compound that includes a chromophore used to impart permanent, semi-permanent, or fleeting color to a macro material such as a fiber or foodstuff or a micro material such as a cell or protein. A chromophore is the portion of the dye compound where the energy difference between at least two orbitals results in the emission of radiation that falls within the visible light spectrum. The emission of radiation that falls within the visible light spectrum (e.g., 380 nm to 750 nm) may be due to photoluminescence (e.g., fluorescence, phosphorescence) or chemiluminescence (e.g., bioluminescence). Chromophores of dyes are often conjugated pi systems. Dyes of the present disclosure are immobilized on a support substrate. After immobilization, the dye may include a functioning chromophore, a chromophore that is reduced in intensity, or a non-functioning chromophore. The chromophore may function when bound to the target molecule, when not bound to the target molecule, or both.

In some embodiments, the dye is photoluminescent. In some such embodiments, the dye is fluorescent. In some embodiments, the dye is chemiluminescent. In some such embodiments, the dye is bioluminescent.

A target protein can interact with one or more dyes through a variety of mechanisms. For example, mechanisms by which some proteins can interact with dyes include electrostatic interactions, hydrophilic/hydrophobic interactions, ionic interactions, hydrogen bonding, pi-pi stacking, or any combination thereof. Some dyes are recognized and bound in the binding pocket of a protein where the endogenous substrate or cofactor binds.

A target oligonucleotide can interact with one or more dyes through a variety of mechanisms. For example, some dyes bind to an oligonucleotide through intercalation. Intercalation is the insertion of at least a portion of a molecule (e.g., a dye) between the planar nucleobases of an oligonucleotide. Some dyes can bind to (e.g., intercalate) single stranded oligonucleotides, double strand oligonucleotides, or both. Other dyes function by binding to a repeating pattern of nucleotides in a target oligonucleotide.

The dyes of the present disclosure may be any dye that can interact with a target molecule. In some embodiments the affinity group includes a selective dye. A selective dye is a dye that can specifically interact with a target molecule. Selective dyes have a higher affinity for the target molecule over other non-target molecules. Separation media that includes a selective dye may be used to purify a target molecule from a mixture that includes other non-target molecules, such as, for example, cell lysates.

In some embodiments, the affinity group includes a non-selective dye. Non-selective dyes non-specifically interact with a target molecule. Non-selective dyes interact with a target molecule and other non-target molecules. The affinity for non-target molecules may be similar to the affinity for the target molecule or the affinity for the non-target molecules can be lower than the affinity for the target molecule. Separation media including a non-selective dye may be used to concentrate a target molecule that has already undergone one or more purification procedures (e.g., an purified target molecule) and/or to transfer the already purified target molecule from a first buffer to a second buffer. For example, an isolation solution including a purified target molecule may be contacted with the membrane and eluted from the membrane using an amount of a second solution that is smaller than the amount of the isolation solution loaded onto the membrane in order to increase the concentration of the target molecule from the isolation solution to the second solution. Separation media including a non-selective dye may be used to exchange an already purified target molecule from a first buffer into a second buffer. For example, a separation media that includes a non-selective dye may be used instead of size exclusion chromatography to conduct a buffer exchange.

Dyes may be classified as natural or synthetic, or by structure. A natural dye is a dye that is isolated from a natural source (e.g., a plant or animal). Examples of natural dyes include indigo (CAS NO: 64784-13-0), tyrian purple (6,6′-dibromoindigo; CAS NO: 1277170-99-6), laccaic acid A (Chemical Abstract Services number (CAS NO.) 1277170-99-6), carminic acid (CAS NO: 1277170-99-6), alizarin (CAS NO: 72-48-0), purpurin (CAS NO: 81-54-9), lawsone (hennotannic acid, CAS NO. 83-72-7), jugalone (CAS NO: 481-39-0), azaleatin (CAS NO: 529-51-1), fustin (CAS NO: 20725-03-5), hematein (CAS NO: 475-25-2), brazilin (CAS NO: 474-07-7), quercitron (CAS NO: 117-39-5), fisetin (CAS NO: 528-48-3), coumarin (CAS NO: 91-64-5), and curcumin (CAS NO: 458-37-7). Natural dyes may be made synthetically. Additionally, natural dyes may be modified to include a reactive handle not normally found on the natural dye.

Dyes may be classified based on structure. Table 1 is dye classification based chemical motifs that can be included in a dye. Dyes classified by based on the inclusion of a motif may be denoted by the statement “motif dye.” For example, a dye having an acridine motif can be termed an acridine dye. The chemical motif may be a core structure, a particular substituent, or both. The chemical motifs listed include isomers and charge variants thereof. Specific dyes having a stated chemical motif may include other chemical groups appended to the motif. For example, the specific dyes may include a functional handle allowing covalent attachment to a support substrate. Table 1 also includes CAS numbers of various dyes classified by chemical motif without any additional chemical groups; the formula of the motif that dyes include examples of specific dyes having the motif; or any combination thereof. Some dyes may include two or more of the motifs and therefore may be able to be classified in two or more of the motif structure classification groups. The separation media of the present disclosure may include one or more affinity ligands that include a dye that has any motif listed in Table 1.

TABLE 1
Motif Dye Classifications

| Motif Classification | Description |
|---|---|
| acridine | CAS NO: 260-94-6 |
| anthraquinone | CAS NO: 84-64-1 |
| anthanthrone | CAS NO: 641-13-4 |
| azine | RR′C═N—N═CRR′ |
| azo | N═N group |
| benzanthrenone | CAS NO: 82-05-3 |
| bisbenzimide | CAS NO: 23491-52-3 (e.g., Hoeschst stain) |
| coumarin | CAS NO: 91-64-5 |
| diarylmethane | CAS NO: 101-81-5 |
| azo | Includes an N═N group |
| Azonium | |
| diazonium | —N(triple bond)N |
| phenazine | CAS NO: 92-82-0 |
| fluorone | CAS NO: 494-41-7 |
| indigoid | derivative of indigotin (CAS NO: 482-89-3) |
| polymethine | odd number of methine groups connected by |
| | alternating single and double bonds |
| | (cyanine dyes; merocyanine dyes) |
| nitro | nitro ortho or para to hydroxyl |
| nitrodiphenylamine | Disperse yellow 26 (CAS NO: 16611-15-7); |
| | Disperse Yellow 42 (CAS NO: 5124-25-4) |
| nitroso | have an NO ortho to an OH |
| Oxazine | include an O and N in a doubly unsaturated |
| | 6 member ring |
| oxazone | nile red (CAS NO: 7385-67-3) |
| prylene | CAS NO: 198-88-0 |
| phthalocyanine | CAS NO: 574-93-6 |
| pyronin | acridine red (CAS NO: 2465-29-4); pyronine |
| | (CAS NO: 92-32-0) |
| phenylindole | 4′,6-Diamidino-2-phenylindole |
| | (CAS NO. 28718-90-3) |
| phenathridine | CAS NO: 229-87-8 |
| phenoxazine | CAS NO: 135-67-1 |
| quinoline | CAS NO: 91-22-5 |
| quinone-imine | Acid Red 103 (CAS NO: 25360-72-9); |
| | Azocarmine G (CAS NO: 25641-18-3) |
| safranin | CAS NO: 477-73-6 |
| stilbene | 1,2-diphenylethene |
| sulfur | include S—C and/or S—S bonds |
| triazine | Aromatic 6 membered ring including 3 nitrogens |
| thiazine | CAS NO: 290-57-3 |
| thiazole | CAS NO: 288-47-1 |
| thioindigo | indigoing where the NH groups are |
| | replaced with S |
| triarylethlamine | Food Blue 2 (CAS NO: 3844-45-9); Acid violet |
| | (CAS NO: 1694-09-4) |
| triarylmethane | CAS NO: 519-73-3 |
| triphenylmethane | CAS NO: 519-73-3 |
| violanthrone | CAS NO: 116-71-2 |
| xanthene | CAS NO: 92-83-1 |

In some embodiments, the separation media of the present disclosure includes an acridine dye. In some embodiments, the separation media of the present disclosure includes an anthraquinone dye. In some embodiments, the separation media of the present disclosure includes an anthanthrone dye. In some embodiments, the separation media of the present disclosure includes an azine dye. In some embodiments, the separation media of the present disclosure includes an azo dye. In some embodiments, the separation media of the present disclosure includes a diazonium dye. In some embodiments, the separation media of the present disclosure includes a phenazine dye. In some embodiments, the separation media of the present disclosure includes a fluorone dye. In some embodiments, the separation media of the present disclosure includes an indigoid dye. In some embodiments, the separation media of the present disclosure includes a polymethine dye. In some embodiments, the separation media of the present disclosure includes a cyanine dye. In some embodiments, the separation media of the present disclosure includes a nitro dye. In some embodiments, the separation media of the present disclosure includes a nitrodiphenylamine dye. In some embodiments, the separation media of the present disclosure includes a nitroso dye. In some embodiments, the separation media of the present disclosure includes an oxazine dye. In some embodiments, the separation media of the present disclosure includes an oxazone dye. In some embodiments, the separation media of the present disclosure includes a prylene dye. In some embodiments, the separation media of the present disclosure includes a phthalocyanine dye. In some embodiments, the separation media of the present disclosure includes a pyronin dye. In some embodiments, the separation media of the present disclosure includes a phenylindole dye. In some embodiments, the separation media of the present disclosure includes a phenathridine dye. In some embodiments, the separation media of the present disclosure includes a quinoline dye. In some embodiments, the separation media of the present disclosure includes a quinone-imine dye. In some embodiments, the separation media of the present disclosure includes a safranin dye. In some embodiments, the separation media of the present disclosure includes a stilbene dye. In some embodiments, the separation media of the present disclosure includes a triazine dye. In some embodiments, the separation media of the present disclosure includes a thiazine dye. In some embodiments, the separation media of the present disclosure includes a thiazole dye. In some embodiments, the separation media of the present disclosure includes a thioindigo dye. In some embodiments, the separation media of the present disclosure includes a triarylethlamine dye. In some embodiments, the separation media of the present disclosure includes a triarylmethane dye. In some embodiments, the separation media of the present disclosure includes a triphenylmethane dye. In some embodiments, the separation media of the present disclosure includes a violanthrone dye. In some embodiments, the separation media of the present disclosure includes a xanthene dye.

In some embodiments, the separation media of the present disclosure includes a selective dye. A non-limiting list of selective dyes are shown in Table 2. While specific example protein classes or specific proteins are listed, these dyes may be used to capture other proteins. For example, a selective dye that binds to a first protein may include a structure that mimics or is related to the structure of an endogenous ligand or cofactor (e.g., nicotinamide adenine dinucleotide NADP) that binds to the first protein. As such, the selective dye may bind to other proteins (e.g., proteins within the same protein class as the first protein) that recognize and bind to the endogenous ligand or cofactor of the first protein.

In some cases, dyes that are selective for protein targets may also bind oligonucleotide targets. In some embodiments, the target molecule is a virus or viral vector such as a lentivirus and the dye is Reactive Red 120, Cibacron Brilliant Yellow 3G-P, or Reactive Blue 4. When such molecules are an affinity groups, the separation group displayed on the surface of the support substrate includes the reaction product between a reactive handle on the affinity groups and a corresponding reactive handle (as discussed herein).

A viral vector is a unidirectional non-propagating gene delivery system. Viral vectors may include proteins displayed on the surface, the proteins able to interact with proteins and/or other molecules exterior to the viral vector.

In some embodiments, the target is not a lentiviral vector and the affinity group includes Reactive Red 120, Cibacron Brilliant Yellow 3G-P, or Reactive Blue 4. In some embodiments, the affinity group does not include Reactive Red 120, Cibacron Brilliant Yellow 3G-P, or Reactive Blue 4.

TABLE 3
Example selective dyes

| Dye | CAS NO | Target | Example Specific Targets |
|---|---|---|---|
| Reactive Red 120 | 61951-82-4 | protein | BSA; lentivirus; NADP⁺ dependent |
| (azo dye) | | | dehydrogenases; enterotoxin A, B, |
| | | | C2 from S. aureus |
| Cibacron Brilliant | 50662-99-2 | protein | NAD⁺ dependent proteins; kinases; |
| Yellow 3G-P (azo | | | dehydrogenases and other enzymes |
| dye/triazine dye) | | | that use an adenylyl-containing |
| | | | cofactor |
| Reactive Blue 4 (Blue | 13324-20-4 | protein | lactate dehydrogenase; lysozyme; |
| MX-R) (triazine dye) | | | BSA |
| Cibacron blue F3GA | 84166-13-2 | protein | nucleotide binding proteins; |
| (Porcine blue HB | | | interferons; dehydrogenases; kinases; |
| reactive 2) (triazine | | | serum albumin |
| dye) | | | |
| Yellow H-A (Reactive | 6539-67-9 | protein | cholesterol ester transfer proteins |
| Yellow 3) (triazine | | | |
| dye) | | | |
| Brown MX 5-BR | 12225-67-1 | proteins | lysozyme, phosphinothricin |
| (Reactive Brown) | | | acetyltransferase |
| (triazine dye) | | | |
| DC 271 | 198696-03-6 | Proteins | DC271 is a retonic acid analog so it |
| | | | may bind to proteins that bind retonic |
| | | | acid (e.g., retinoid binding protein II) |
| IHR-Cy3 | PubChem ID is | Protein | Binds Smoothened (Smo) |
| | 122705984 | | |

In some embodiments, the separation media of the present disclosure include a selective dye that is an azo dye. In some embodiments, the separation media of the present disclosure include a selective dye that is a triazine dye.

In some embodiments, the separation media of the present disclosure includes a non-selective dye. Non-limiting examples of non-selective dyes are listed in Table 3 along with their target molecule class and a commercial vendor from which the dyes can be procured. In Table 3, the statement “dye name series” includes all dyes that fall within the dye name. For example, the TOTO (thiazole orange homodimer) series includes at least TOTO-1 and TOTO-3. In Table 3, Millipore Sigma is located in Burlington, MA; Biotium is located in Freemont, MA; ThermoFischer is located in Waltham, MA; Invitrogen is located in Carlsbad, CA; and Applied Biosystems is located in Foster City, CA.

In some embodiments, the separation media of the present disclosure includes a non-specific dye from Table 3 that binds oligonucleotides. In some embodiments, the separation media of the present disclosure includes a non-specific dye from Table 3 that binds proteins.

TABLE 3
Example non-selective dyes

| | Dye Core | Target molecule | |
|---|---|---|---|
| Dye Identity | structure | type | Available from |
| COOMASSIE BRILLIANT | triphenylmethane | protein | Millipore Sigma |
| BLUE series (e.g., R-250 | | | |
| and G-250) | | | |
| ONE STEP (e.g., Blue, | | protein | Biotium |
| Lumitein, and Lumitein UV) | | | |
| SYPRO series (e.g., ruby, | cyanine | protein | ThermoFischer |
| orange, tangerine) | (merocyanine) | | |
| ORIOLE | | protein | BioRad |
| FLAMINGO | | protein | BioRad |
| GELRED | phenathridine | oligonucleotide | Biotium |
| GELGREEN | phenathridine | oligonucleotide | Biotium |
| DNAZURE | | oligonucleotide | Biotium |
| EMBER500 | | oligonucleotide | Biotium |
| SYBR series (e.g., green | polymethine | oligonucleotide | Applied |
| and gold) | (cyanine) | | Biosystems |
| ethidium bromide | phenathridine | oligonucleotide | Millipore Sigma |
| acridine orange | acridine | oligonucleotide | ThermoFischer |
| 9-amino-6-chloro-2- | acridine | oligonucleotide | ThermoFischer |
| methoxyacridine | | | |
| BOBO dye series | polymethine | oligonucleotide | ThermoFischer |
| | (cyanine) | | |
| DAPI dye series | phenylindole | oligonucleotide | ThermoFischer |
| dihydroethidium | phenathridine | oligonucleotide | ThermoFischer |
| ethidium homodimer-1 | phenathridine | oligonucleotide | ThermoFischer |
| ethidium monoazide | phenathridine | oligonucleotide | ThermoFischer |
| hexidium iodide | phenathridine | oligonucleotide | ThermoFischer |
| Hoechst series | bisbenzimide | oligonucleotide | ThermoFischer |
| LDS 751 | | oligonucleotide | ThermoFischer |
| POPO series | polymethine | oligonucleotide | ThermoFischer |
| | (cyanine) | | |
| propidium iodide | phenathridine | oligonucleotide | ThermoFischer |
| OIL GREEN | polymethine | oligonucleotide | ThermoFischer |
| | (cyanine) | | |
| PICO GREEN | polymethine | oligonucleotide | ThermoFischer |
| | (cyanine) | | |
| RIBO GREEN | polymethine | oligonucleotide | ThermoFischer |
| | (cyanine) | | |
| SYTO series | polymethine | oligonucleotide | ThermoFischer |
| | (cyanine) | | |
| SYTOX series | polymethine | oligonucleotide | ThermoFischer |
| | (cyanine) | | |
| TO-PRO | polymethine | oligonucleotide | ThermoFischer |
| | (cyanine) | | |
| TOTO series | polymethine | oligonucleotide | ThermoFischer |
| | (cyanine) | | |
| YO-PRO | polymethine | oligonucleotide | ThermoFischer |
| | (cyanine) | | |
| YOYO series | polymethine | oligonucleotide | ThermoFischer |
| | (cyanine) | | |
| JOJO series | polymethine | oligonucleotide | Invitrogen |
| | (cyanine) | | |
| LOLO series | polymethine | oligonucleotide | Invitrogen |
| | (cyanine) | | |
| Ponceau S | Azo | protein | ThermoFischer |
| VERSABLOT | | protein | Biotium |
| GR Dye | polymethine | oligonucleotide | ThermoFischer |

In some embodiments, the separation media includes a non-selective polymethine dye. In some embodiments, the separation media includes a non-selective azo dye. In some embodiments, the separation media includes a non-selective cyanine dye. In some embodiments, the separation media includes a non-selective phenathridine dye. In some embodiments, the separation media includes a non-selective triphenylmethane dye. In some embodiments, the separation media includes a non-selective bisbenzimide dye. In some embodiments, the separation media includes a non-selective phenylindole dye. In some embodiments, the separation media includes a non-selective phenylindole dye. In some embodiments, the separation media includes a non-selective acridine dye. In some embodiments, the separation media includes a non-selective thiazine dye.

In some embodiments, the separation media includes a dye that is commonly used as a histology stain. Example histology stains include methylene blue (CAS NO. 61-73-4; thiazine dye); crystal violet (CAS NO. 54806209; triarylmethane dye); malachite green (CAS NO. 569-64-2, 2437-29-8; triarylmethane dye); basic fuchsin (CAS NO. 632-99-5; triarylmethane dye); acidic fuchsin (CAS NO. 3244-88-0; triarylmethane); safranin (CAS NO. 477-73-6); eosins series (e.g., eosin Y, eosin B; xanthene dyes); Rose Bengal (CAS NO. 4159-77-7; xanthene dye); Congo Red (CAS NO. 573-58-0; azo dye); toluidine blue (CAS NO. 92-31-9; thiazine); orcein (CAS NO. 1400-62-0); and hematoxylin (CAS NO. 517-28-2). In some embodiments, the separation media includes a histology dye that is a triarylmethane dye, a thiazine dye, or a xanthene dye.

The affinity groups of the present disclosure include the reaction product of a reactive handle on the support substrate and a reactive handle on a dye. Example reactive handles are described herein. Some dyes, such as those described herein, already include one or more reactive handles. Alternatively, or additionally, a dye may be modified to install one or more reactive handles enabling covalent attachment to the support substrate.

In some embodiments, the separation media includes a plurality of separation ligands that include a separation group that is an assistance group. An assistance group is a chemical moiety that facilitates the binding of the target molecule to the affinity group; binds the target molecule through electrostatic interactions and/or hydrophobic interactions; or both. In some embodiments, the assistance group may allow for a high density of target molecules to bind to separation ligands that include an affinity group. In some embodiments, the assistance group may aid in attracting the target molecule to the support substrate such as to allow for the target molecule to be in proximity to a separation group that includes an affinity group. For example, the assistance group may be ionizable or possess a formal charge which may be opposite the charge of the target molecule. In such cases, the oppositely charged assistance group may attract the target molecule to the support substrate which may allow the target molecule to bind to the affinity group.

In some embodiments, the assistance group functions as a cation or anion exchange chromatography ligand. Anion exchange ligands have a positively charged functional group that targets negatively charged target molecules through electrostatic interactions. The anion exchange ligand may possess a formal positive charge, or the positive charge can be induced through the pH of the solution that the anion exchange ligand is exposed to. Cation exchange ligands have a positively charged functional groups that target negatively charged target molecules through electrostatic interactions. The cation exchange ligand may possess a formal negative charge, or the negative charge can be induced through the pH of the solution that the cation exchange ligand is exposed to.

In some embodiments, the assistance group possesses a positive formal charge or is ionizable under certain pH conditions to have a positive charge. Such assistance groups may be beneficial when the target molecule has a negative formal charge. Examples of such assistance groups include primary, secondary, tertiary, and quaternary amines. Suitable amines may be diamines, triamines, and polyamines.

Examples of primary amines include methylene diamine, ethylene diamine, propylene diamine, butylenediamine (putrescine), pentylamine, or any aliphatic diamine with 1-18 carbons between the terminal amines, covalently attached to the support substrate via one of the amines. Such ligands can be made from polyamines such as ethylene diamine, diethylenetriamine, triethylenetetramine covalently attached via one of the amines.

Examples of secondary amines can include any of the aforementioned primary amines immobilized to the substrate, substituted with an additional R-group as described above. In cases in which diamines are used, secondary amines may also be formed by covalent interaction with the substrate coupling both amines to the substrate. Ligands containing secondary amines with the structure of the ligand may also be immobilized such as linear polyethyleneimine, spermidine, or spermine. Furthermore, groups containing a non-terminal primary amine (e.g., 3-aminopentane) may also be conjugated to the substrate to result in a secondary amine.

Examples of suitable tertiary amines include N,N-dimethylethylenediamine; N,N-dimethylpropylenediamine; N,N-diethylpropylenediamine; or any aliphatic diamine with aliphatic carbon group substitution on one or both amines ranging from one to six carbons, with a linker having 2-18 carbons between the terminal amines.

Examples of quaternary amines include any of the aforementioned primary amines that have undergone a quaternarization reaction resulting in a permanent positive charge. Such reactions can be performed with alkyl groups such as methyl iodide or aryl groups such as benzyl iodide. Quaternary amines can further include any of the aforementioned tertiary amines that have undergone a quaternarization reaction resulting in a permanent positive charge. Such reactions can be described by the Menshutkin reaction which uses an alkyl halide to form a quaternary ammonium salt from a reaction with a tertiary amine. Such reactions can be performed with alkyl containing groups of varying length such as butyl bromide or aryl groups such as benzyl chloride or any combination thereof. Additionally, compounds containing quaternary amines can be immobilized on the support substrate directly.

In other embodiments, the assistance group possesses a negative formal charge or is ionizable under certain pH conditions to have a negative charge. Such assistance group may be beneficial when the target molecule has a positive formal charge. The difference in charge of target molecule and the assistance molecule may allow for an electrostatic interaction between the target molecule and the assistance group thereby allowing the target molecule to be proximate to the support surface and the affinity groups which may increase the probability of the target molecule of binding to an affinity group.

In some embodiments, the assistance group is such that it can induce hydrophobic interactions with the target molecules. Hydrophobic interactions exploit the differences in hydrophobicity between the target molecules and possible impurities in the isolation solution. In one embodiment, such ligands include aliphatic chains with three carbons or longer (common used lengths include butyl, pentyl, hexyl, heptyl, octyl, nonyl, decyl, undecyl, and dodecyl), benzyl, phenyl, phenol, pyridine, boronic acid groups, branched polymers such as polypropylene glycol, and sulfur-containing thiophilic ligands such as propanethiol, 2-butanethiol, 3,6-dioxa-1,8-octanedithiol, octanethiol, benzyl mercaptan, 2-mercaptopyridine, thiophenol, 1,2-ethanedithiol, 1,4-benzenedimethanethiol, 2-phenylethanethiol, and the like, and any combination thereof.

In some embodiments, separation ligands that include an assistance group can be directly incorporated into a functionalized layer of a support substrate through polymerization of a monomer that includes an assistance group.

In some embodiments, the separation media includes a plurality of separation ligands that includes a separation group that is a capping group. A capping group is a chemical moiety that prevents reactive groups of the support substrate from reacting with the target molecule or any other molecule in the isolation solution. A capping group may be employed to block support substrate reactive handles that have not reacted with other separation ligands. A capping group may be used to cap the end of a polymer chain. Capping groups may be any chemical group that is non-reactive towards the target molecule or other molecules in the isolation solution.

In some embodiments, a separation ligand immobilized on a support substrate has the formula (SLim)

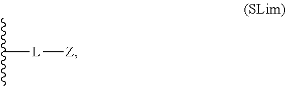

where L is a linker, Z is a separation group, and the vertical black line is the support substrate.

Each separation ligand of the plurality of separation ligands has the formula SL

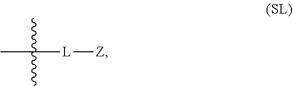

where L is a linker and Z is a separation group. L separates the support substrate from Z. The separation group may include an affinity group, an assistance group, capping group, or assistance group. The affinity group may be any affinity group as disclosed herein. The assistance group may be any assistance group as described herein. The capping group may be any capping group as disclosed herein. The assistance group may be any capping group as disclosed herein. Separation ligands of multiple chemical compositions may be immobilized to a single support substrate. For example, a support substrate may include a first portion of a separation ligands of formula -L-Z and a second portion of separation ligands of formula -L-Z. In some embodiments, the first portion and the second portion of separation ligands include the same separation group (Z) but have different linkers (L). In other embodiments, the first portion and the second portion of the separation ligands may have the same linker (L) but have different separation groups.

In some embodiments, L is of formula L1 such that the separation ligand of formula SL is of formula SL1.

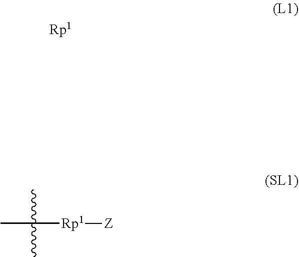

where Rp¹ is a reaction product, and Z is the separation group. A reaction product is the chemical group resulting from the reaction of two cooperative functional handles (as discussed herein). In a separation ligand of formula SL1, the linker is the reaction product. The reaction product Rp¹ links the support substrate (not shown) and the separation group (Z). A covalent bond from Rp¹ to the support substrate is the point of covalent attachment of the linker (L1) to the support substrate. A covalent bond from Rp¹ to the separation group (Z) is the point of covalent attachment of the linker (L1) to the separation group (Z). Rp¹ may be any reaction product as disclosed herein.

The reaction product (Rp¹) may be the reaction product between any two cooperative reactive handles (as described herein). Examples of reaction products include amides, ureas, thioureas, carbamates, carbonates, esters, thioethers, ethers, and triazoles. In some embodiments, a reaction product (e.g., such as Rp¹) is Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof. The chemical structure of Rp^{A}-Rp^{M} are shown below.

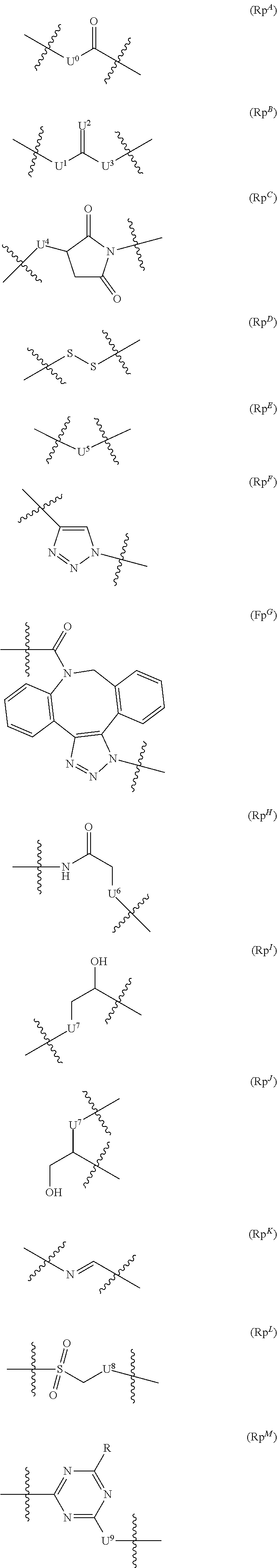

where U⁰, U⁴, U⁵, U⁶, U⁷, U⁸ and U⁹ are independently NH, N, O, or S. For Rp^{B} each of U¹, U², and U³ are independently NH, N, O, or S. R in Rp^{M} may be H, an organic group, or a halogen. The reaction products have two connection points, each of which may be covalently linked to the support substrate or any component of a separation ligand. For separation ligands of formula SL1, one connection point the reaction product Rp¹ is linked to the separation group while the other connection point of the reaction product Rp¹ is linked to the support substrate.

In some embodiments where the separation ligand is of formula SL1, Rp¹ is Rp^{A} where U⁰ is NH. In some such embodiments, the amide nitrogen (U⁰) of Rp^{A} is covalently linked to the separation group. In other such embodiments, the amide nitrogen of Rp^{A} is covalently linked to the support substrate.

In some embodiments where the separation ligand is of formula SL1, Rp¹ is Rp^{A} where U⁰ is O. In some such embodiments, the ester oxygen (U⁰) of Rp^{A} is covalently linked to the separation group. In other such embodiments, the ester oxygen of Rp^{A} is covalently linked to the support substrate.

In some embodiments where the separation ligand is of formula SL1, Rp¹ is Rp^{L} where U⁸ is O. In some such embodiments, oxygen is covalently linked to the separation group. In other such embodiments, the oxygen is covalently linked to the support substrate.

In some embodiments where the separation ligand is of formula SL1, Rp¹ is RPM where U⁹ is O and R is a halogen. In some such embodiments, the oxygen is covalently linked to the separation group. In other such embodiments, the oxygen is covalently linked to the support substrate.

The identity of a reaction product (e.g., Rp¹) depends at least in part on the type of conjugation chemistry used to form the reaction product. In a conjugation reaction, each component being linked together includes a reactive handle, such that the reactive handles are cooperative reactive handles. Components that include a reactive handle for conjugation reactions are termed precursor compounds or precursors. A precursor compound includes the component and a reactive handle covalently linked to the component. Cooperative handles or cooperative reactive handles are two or more reactive handles that when exposed to each other under favorable reaction conditions a conjugation reaction occurs to form a reaction product between the reactive handles. Components that have been conjugated through a conjugation reaction may be referred to as a conjugate. For example, component A and component B are to be conjugated through a conjugation reaction. The component A precursor includes a reactive handle X. The component B precursor includes a reactive handle Y. X and Y are cooperative. A conjugation reaction between the component A precursor and the component B precursor results in the formation of an A-B conjugate that includes the reaction product between X and Y. It is understood that the notation of a conjugate is from the perspective of the conjugated components, not the precursors of those components (i.e., A-B conjugate not A precursor-B precursor conjugate). This is because upon completion of the conjugation reaction, the precursor components are no longer precursors. In the case of a component precursor that includes two independently reactive handles, one of which has been reacted with a different component precursor to form a conjugate, the conjugate notation is still from the perspective of the conjugated components, not the precursor components, with the understanding that the conjugate includes the unreacted second reactive handle. For example, a component D precursor includes a first reactive handle J and a second reactive handle Z. The component B precursor has the reactive handle Y. J and Y are cooperative handles. A conjugation reaction between the component A precursor and the component B precursor results in the formation of an A-B conjugate that includes the reaction product between J and Y. The A-B conjugate also includes the unreacted second reactive handle Z.

Any pair of cooperative reactive handles may be used to form a reaction product of the present disclosure. Examples of cooperative handles include an activated ester and an amine; an amine and an NHS-ester; a hydroxyl and an NHS-ester; a hydroxyl and an epoxide; an acyl chloride and an amine; and acyl chloride and a alcohol; an amine and an epoxide; a thiol and an epoxide; a thiol and a maleimide; a disulfide and a thiol; an azide and an alkyne (azide and a linear alkyne in the presence of Cu(I); an azide and a cyclic alkyne such as cyclooctyne, difluorinated cyclooctyne, dibenxocyclooctyne, TMTH-SulfoxImine, biarylazacyclooctynone, or bicyclo[6.1.0]nonyne); an amine and an isocyanate; an amine and an isothiocyanate, a amine and a benzoyl fluoride; a thiol and a Iodoacetamide; a thiol and a bromoacetamide; a disulfide and 2-thiopyridine; a thiol and 3-arylpropiolonitirle; a phenol and a diazonium salt; a phenol and 4-phenyl-1,2,4-triazoline-3,5-dione; a phenol, an aldehyde, and a aniline; a hydroxyl and sodium periodate; a thiol and an iodoacetamide; an amine and a pyridoxal phosphate; an azide and a functionalized triphenyl phosphine; a tetrazine and a strained alkene; a vinyl sulfone and a hydroxyl; a halotriazine (e.g., dichlorotriazine) and a hydroxyl; and the like.

Examples of individual reactive handles that may be used to form the separation media of the present disclosure include Rh^{A} (hydroxyl), Rh^{B} (thiol), Rh^{C} (amine), Rh^{D} (activated ester), Rh^{E} (azide), Rh^{F} (alkyne), Rh^{G} (NHS-ester), Rh^{H} (maleimide), Rh^{I} (where X is a Cl, Br, or I leaving group attached to carbon that can undergo nucleophilic substitution; e.g., a bromoacetamide or iodoacetamide), Rh^{I} (cyclooctyne), Rh^{K} (isocyanate), Rh^{L} (isothiocyanate), Rh^{M} (where X is a Cl, Br, or I leaving group attached to carbon that can undergo nucleophilic substitution), Rh^{N} (an epoxide), Rh^{O} (an acyl chloride), Rh^{P} (aldehyde), R^{Q} (halotriazine where X is Cl, I, or Br and R is an organic group, H or a halogen), Rh^{R} (vinyl sulfone), and isomers thereof. Chemical structures of Rh^{A}-Rh^{R} are depicted below.

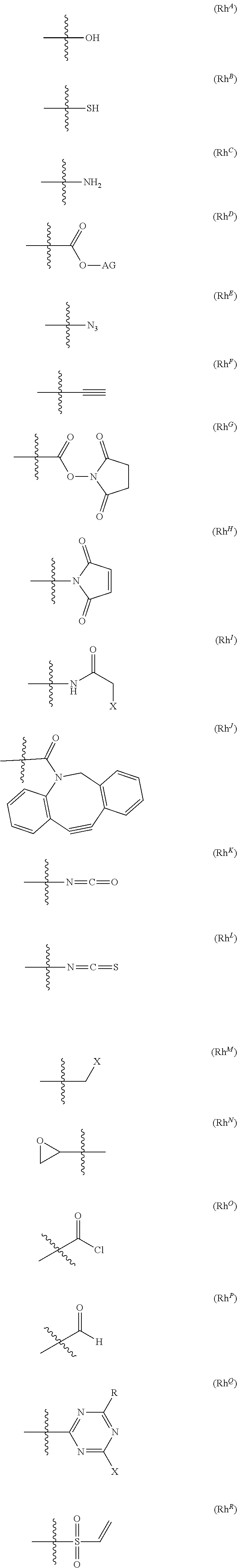

Rh^{D} is an activated ester where AG is an activating group. An activated ester is an ester that is reactive with an activated ester cooperative reaction handle (e.g., an amide) in a conjugation reaction. Activated esters may be denoted as the type of activated ester or by the activating group. Examples of activating groups include O-acylisoureas, benzotriazoles (with a bond between the ester oxygen and one nitrogen of the triazole), and pentafluorophenyl. In some embodiments, Rh^{D} may be an activated ester of a carboxylic acid. In such embodiments, the activated ester is formed through the reaction of a carboxylic acid with one or more reagents that install the activating group. For example, a carboxylic acid may be converted into an activated ester having a O-acylisoureas activating group by treating the carboxylic acid with various carbodiimide reagents (e.g., N,N′-dicyclohexylcarbodiimide, 1-ethyl-3-(3 dimethylaminopropyl)carbodiimide, diisopropylcarbodiimide (DIC)) under favorable reaction conditions. A carboxylic acid may be converted into an activated ester having a benzotriazole activating group by treating the carboxylic acid with various carbodiimide reagents followed by treatment with hydroxybenzotriazole (HOBT) or by treating the carboxylic acid with various benzotriazole containing compounds (e.g., O-(Benzotriazol-1-yl)-N,N,N′,N′-tetramethyluronium hexafluorophosphate (HBTU); O-(Benzotriazol-1-yl)-N,N,N′,N′-tetramethyluronium tetrafluoroborate (TBTU); 2-(1H-benzotriazol-1-yl)-1,1,3,3-tetramethyluronium hexafluorophosphate (HBTU); benzotriazol-1-yloxy)tris(dimethylamino)phosphonium hexafluorophosphate (BOP); (benzotriazol-1-yloxy)tripyrrolidinophosphonium hexafluorophosphate (PyBOP); and O-(7-Azabenzotriazol-1-yl)-N,N,N′,N′-tetramethyluronium tetrafluoroborate (TATU) under favorable reaction conditions. Other reagents are available for making activated esters from carboxylic acids including bromotripyrrolidinophosphonium hexafluorophosphate (PyBrOP); O—(N-suc-cinimidyl)-1,1,3,3-tetramethyl-uronium tetrafluoroborate (TSTU); O-(5-norbornene-2,3-dicarboximido)-N,N,N′,N′-tetramethyluronium tetrafluoroborate (TNTU); O-(1,2-dihydro-2-oxo-1-pyridyl-N,N,N′,N′-tetramethyluronium tetrafluoroborate (TPTU); and 3-(diethylphosphoryloxy)-1,2,3-benzotriazin-4 (3H)-one (DEPBT); carbonyldiimidazole. In some embodiments, the activated ester may be created in situ from a carboxylic acid and not isolated prior to a conjugation reaction.

Rh^{O} is an acyl chloride. Acyl chlorides may be prepared from carboxylic acids, for example, using thionyl chloride. Acyl chlorides may not be stable and as such, may be prepared in situ and not isolated prior to a conjugation reaction.

Reactive handles Rh^{A}, Rh^{B}, Rh^{C}, Rh^{D}, Rh^{E}, Rh^{F}, Rh^{G}, Rh^{H}, Rh^{I}, Rh^{J}, Rh^{K}, Rh^{L}, Rh^{M}, Rh^{N}, Rh^{O}, Rh^{P}, Rh^{Q}, and Rh^{R} include various pairs of cooperative handles that can form the reaction products of Rp^{A}, Rp^{B}, Rp^{C}, Rp^{D}, Rp^{E}, Rp^{F}, Rp^{G}, Rp^{H}, Rp^{I}, Rp^{J}, Rp^{L}, and Rp^{M}. For example, under favorable reaction conditions, a conjugation reaction between Rh^{A} and Rh^{D} forms Rp^{A} where U⁰ is O. Under favorable reaction conditions, a conjugation reaction between Rh^{D} and Rh^{C} forms Rp^{A} where U⁰ is NH. Under favorable reaction conditions, a conjugation reaction between Rh^{C} and Rh^{G} forms Rp^{A} where U⁰ is NH. Under favorable reaction conditions, a conjugation reaction between Rh^{B} and Rh^{H} forms Rp^{C} where U⁴ is S. Under favorable reaction conditions, a conjugation reaction between two Rh^{B} forms Rp^{D}. Under favorable reaction conditions, a conjugation reaction between Rh^{C} and Rh^{I} forms Rp^{H} where U⁶ is NH. Under favorable reaction conditions, a conjugation reaction between Rh^{B} and Rh^{I} forms Rp^{H} where U⁶ is S. Under favorable reaction conditions, a conjugation reaction between Rh^{M} and Rh^{B} forms Rp^{E} where U⁵ is S. Under favorable reaction conditions, a conjugation reaction between Rh^{M} and Rh^{C} forms Rp^{E} where U⁵ is NH. Under favorable reaction conditions, a conjugation reaction between Rh^{K} and Rh^{C} forms Rp^{B} where U¹ and U³ are NH and U² is O. Under favorable reaction conditions, a conjugation reaction between Rh and Rh^{C} forms Rp^{B} where U¹ and U³ are NH and U² is S. Under favorable reaction conditions, a conjugation reaction between Rh^{F} and Rh^{E} forms Rp^{F}. Under favorable reaction conditions, a conjugation reaction between Rh^{J} and Rh^{E} forms Rp^{G}. Under favorable reaction conditions, a conjugation reaction between Rh^{N} and Rh^{A} forms Rp^{I} or Rp^{J} where U⁷ is O. Under favorable reaction conditions, a conjugation reaction between Rh^{N} and Rh^{B} forms Rp^{I} or Rp^{J} where U⁷ is S. Under favorable reaction conditions, a conjugation reaction between Rh^{N} and Rh^{C} forms Rp^{I} or Rp^{J} where U⁷ is N. Under favorable reaction conditions, a conjugation reaction between Rh^{O} and Rh^{A} forms Rp^{A} where U⁰ is O. Under favorable reaction conditions, a conjugation reaction between Rh^{O} and Rh^{B} forms Rp^{A} where U⁰ is NH. Under favorable reaction conditions, a conjugation reaction between Rh^{P} and Rh^{C} forms Rp^{K}. Under favorable reaction conditions, a conjugation reaction between Rh^{A} and Rh^{Q} forms Rp^{M} where U⁹ is O. Under favorable reaction conditions, a conjugation reaction between Rh^{A} and Rh^{R} forms Rp^{L} where U⁹ is O.

Conjugation reactions between cooperative handles may be done under favorable reaction conditions. Favorable reaction conditions are conditions that facilitate a reaction, increase the yield of a reaction, minimize unwanted biproducts of a reaction, and/or increase the rate of a reaction. Example reaction conditions include reaction temperature, reaction atmosphere composition, reaction solvent, the presence of a catalyst, the presence of a base, the presence of an acid, and any combination thereof. Favorable reaction conditions for conjugation reactions are known.

Cooperative handles may be chosen such that the conjugation reaction is an orthogonal conjugation reaction. Orthogonal conjugation reactions are reactions where the chemistry is selective such that only two cooperative handles react to form a reaction product even when additional reactive handles or pairs of cooperative reactive handles may be present. Orthogonal conjugation reactions may be useful because they allow for multiple selective conjugation reactions to take place in series or in parallel. Orthogonality of two or more conjugation reactions may be achieved by choosing reactive handles that are only reactive with their cooperative counterpart in the presence of other cooperative reactive handle pairs. Orthogonality of two or more conjugation reactions may also be achieved by using reactive handles that are reactive with multiple cooperative counterparts, but the reactivity can be influenced through the reaction conditions such that only a specific pair of cooperative handles will react in the given set of reaction conditions.

To form a separation ligand of formula SL1, conjugation reaction precursor compounds are employed, each precursor compound having a reactive handle that is cooperative with the reactive handle of a different precursor compound. In some embodiments, a separation ligand of formula SL1 is formed through the conjugation of a separation group precursor of formula Pre-Z(1) and a support substrate precursor of formula Pre-M(1) by way of synthetic scheme S1. The support substrate precursor includes a reactive handle Rh¹ that is covalently attached to the support substrate (shown as a thick black vertical line). The separation group precursor includes the separation group (Z) of formula SL1 and a separation group reactive handle Rh². Rh¹ and Rh² are cooperative reactive handles and may be any pair of cooperative reactive handles as disclosed herein. In scheme S1, the support substrate reactive handle (Rh¹) is reacted with the separation group reactive handle (Rh²) to from a reaction product (Rp¹) thereby forming a separation ligand of formula SL1.

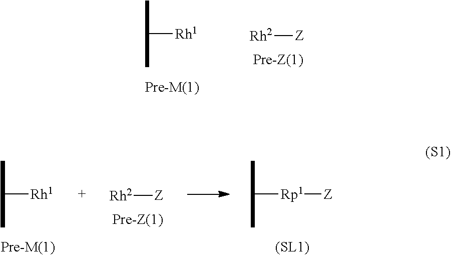

In some embodiments the material of the support substrate does not include a reactive handle that is cooperative with the separation group reactive handle (Rh²). In such embodiments, scheme S1 may further include installing the support substrate reactive handle Rh¹. The support substrate reactive handle Rh¹ may be installed through treatment of the support substrate to form the Rh¹. In such embodiments, a chemical functionality already present on the support substrate is transformed into the support substrate reactive handle. For example, the support substrate may be exposed to an oxidizing or reducing reagent (or conditions). The support substrate reactive handle Rh¹ may be installed through the installation of a functionalized layer. In such embodiments, the functionalized layer is considered a part of the support substrate. In such embodiments, the reactive handle of functionalized layer is the support substrate reactive handle. Examples of materials suitable for a functionalized layer are discussed herein.

In some embodiments, the reactive handle of the dye affinity group may be separated from the core of the dye structure by a linker. The linker can be of any length and any composition that does not completely inhibit the ability of the separation group to bind the target molecule and/or completely inhibit the conjugation reaction of the separation group precursor with the support substrate precursor.

In some embodiments, the linker (L) is of formula L2 such that SL is of formula SL2; that is:

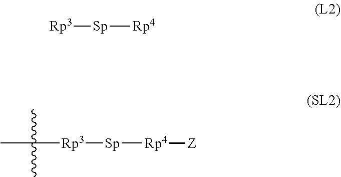

In formulas L2 and SL2, Sp is a spacer, Rp³ is a first reaction product, and Rp⁴ is a second reaction product. In formula SL2, Z is the separation group. The linker of formula L2 includes Sp, Rp³ and Rp⁴. In a separation ligand of formula SL2, a covalent bond from Rp³ to the support substrate is the point of covalent attachment of the linker (L2) to the support substrate. A covalent bond from Rp⁴ to the separation group (Z) is the point of covalent attachment of the linker (L2) to the separation group (Z). Rp³ and Rp⁴ may be any reaction product as described herein.

In some embodiments where the separation ligand is of formula SL2, Rp³, Rp⁴, or both are Rp^{A} where U⁰ is NH. In some such embodiments, the amide nitrogen (U⁰) of Rp^{A} is covalently linked to the support substrate or covalently linked to the separation group. In other such embodiments, the amide nitrogen of Rp^{A} is covalently linked to the spacer.

In some embodiments where the separation ligand is of formula SL2, Rp³, Rp⁴, or both are Rp^{A} where U⁰ is O. In some such embodiments, the ester oxygen (U⁰) of Rp^{A} is covalently linked to the support substrate or covalently linked to the separation group. In other such embodiments, the ester oxygen of Rp^{A} is covalently linked to the spacer.

The spacer (Sp) of the linker (L1) may be of any length and/or chemical composition that does not completely inhibit the formation of the first reaction product and the second reaction product. The spacer (Sp) may be of any length and/or chemical composition that does not completely inhibit the ability of the affinity group to bind to its intended target.

The spacer (Sp) includes a divalent organic group. The divalent organic group includes a backbone. The backbone is the longest contiguous chain of atoms within the spacer (Sp). In some embodiments, the backbone is a carbon-based backbone. A backbone that is carbon-based is a backbone that has a greater number of carbon atoms than heteroatoms in the backbone. The backbone may include one or more substitutions extending from the backbone and/or one or more functional groups catenated within the backbone.

In some embodiments, the backbone is an alkanediyl (divalent group that is a radical of an alkane) or an alkenediyl (divalent group that is a radical of an alkene). The alkanediyl or alkenediyl may have a backbone chain length of C1 to C18, C1 to C10, C1 to C6, C1 to C4, C1 to C3, or C2 to C4. An alkenediyl may have one or more double bonds. The one or more double bonds may be located at any point along the backbone.

In some embodiments, the backbone includes one or more catenated functional groups. Catenated functional groups have at least one atom that is a part of the backbone; that is, at least one atom of the functional group lies within the backbone chain. The at least one atom of the functional group that is a part of the backbone can be a carbon or a heteroatom. For example, in some embodiments, the backbone includes a catenated ketone where the carbon atom of the carbonyl of the ketone is a part of the backbone. In other embodiments, the backbone includes a catenated amide. In some such embodiments, the nitrogen of the catenated amide is a part of the backbone and the carbon of the carbonyl is not a part of the backbone. In other such embodiments, the nitrogen and the carbonyl carbon of the amide are a part of the backbone. Example catenated functional groups include, ethers; thioethers; esters (where the ester oxygen atom is a part of the backbone, or where the ester oxygen and the carbonyl carbon are a part of the backbone); thioesters (where the thioester sulfur atom is a part of the backbone, or where the thioester sulfur atom and the carbonyl carbon are a part of the backbone); amides (where the amide nitrogen is a part of the backbone, or where the amide nitrogen and the carbonyl carbon are a part of the backbone); ureas (where one of the urea nitrogens is a part of the backbone, or where both of the urea nitrogens and the carbonyl carbon are a part of the backbone); carbamates (where the carbamate oxygen is a part of the backbone; the carbamate nitrogen is a part of the backbone; or the carbamate oxygen, the carbamate nitrogen, and the carbonyl carbon are a part of the backbone); thioureas (where one of the urea nitrogens is a part of the backbone, or where both of the urea nitrogens and the carbonyl carbon are a part of the backbone); secondary and tertiary amines; aromatic rings (where at least two atoms of the aromatic ring are a part of the backbone); and any combination thereof.

In some embodiments the spacer includes a catenated ether (i.e., a catenated oxygen atom). In some such embodiments, the backbone includes a polyethylene glycol chain of 1, 2, 3, 4, 5, 6, 7, 8, 9, or 10 —OCH₂CH₂— repeat units. In some embodiments, the spacer includes a catenated ketone. In some such embodiments, the spacer is of the formula —(CO)— (i.e., the backbone is a C1 alkanediyl and the C1 is the carbonyl carbon of the catenated ketone).

In some embodiments where the separation ligand is of formula SL2, Rp³ and Rp⁴ are both Rp^{E} where each U⁵ is independently O, NH, or S. In some embodiments, the U⁵ of Rp³ is O and the U⁵ of Rp⁴ is O. In some embodiments, the U⁵ of Rp³ is NH and the U⁵ of Rp⁴ is NH. In some embodiments, the U⁵ of Rp³ is O and the U⁵ of Rp⁴ is NH. In some embodiments, the U⁵ of Rp³ is NH and the U⁵ of Rp⁴ are O.

In some embodiments where Rp³ and Rp⁴ are both Rp^{E}, Sp may be —C(O)—. In some such embodiments, L2 may be described as Rp^{B}. In some embodiments were L2 is Rp^{B}, U² is O. In some embodiments were L2 is Rp^{B}, U¹ is O. In some embodiments were L2 is Rp^{B}, U³ is O. In some embodiments were L2 is Rp^{B}, U¹ is NH. In some embodiments were L2 is Rp^{B}, U³ is NH. In some embodiments were L2 is Rp^{B}, U¹ is O, U² is O, and U³ is NH. In some embodiments were L2 is Rp^{B}, U¹ is NH, U² is O, and U³ is O.

In some embodiments where the separation ligand is of formula SL2, Rp³ is Rp^{E} and Rp⁴ is Rp^{I} or Rp^{J} where U⁵ and U⁷ are each independently O, NH, or S. In some embodiments U⁵ is NH and U⁷ is NH. In some embodiments U⁵ is O and U⁷ is O. In some embodiments U⁵ is NH and U⁷ is O. In some embodiments U⁵ is O and U⁷ is NH.

In some embodiments where Rp³ and Rp⁴ are both Rp^{E}, Sp may be —(CH₂)ₙ— where n is 0, 1, 2, 3, 4, 5, 6, 7, 8, 9, or 10. In some such embodiments, L2 is of the formula

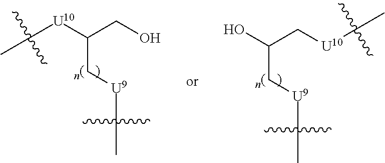

where U⁹ and U¹⁰ are each independently O, NH, or S and n is 0, 1, 2, 3, 4, 5, 6, 7, 8, 9, or 10. U⁹ may be U⁵ from Rp^{I} and U¹⁰ may be U⁷ from Rp^{J}. In some embodiments U⁹ is NH and U¹⁰ is NH. In some embodiments U⁹ is O and U¹⁰ is O. In some embodiments U⁹ is NH and U¹⁰ is O. In some embodiments U⁹ is O and U¹⁰ is NH.

In some embodiments, a separation ligand of formula SL is of formula

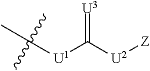

where U¹, U², and U³ are each independently O, NH, or S and Z is a separation group. For example, in some embodiments, a separation ligand of formula SL is

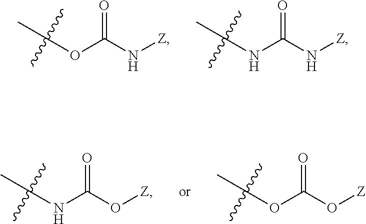

where Z is a separation group. In some embodiments, Z is an affinity group.

In some embodiments, a separation ligand of formula SL is of formula

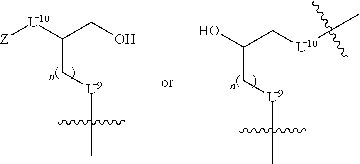

U⁰ and U¹⁰ are each independently O, NH, or S where Z is a separation group. In some embodiments, SL is

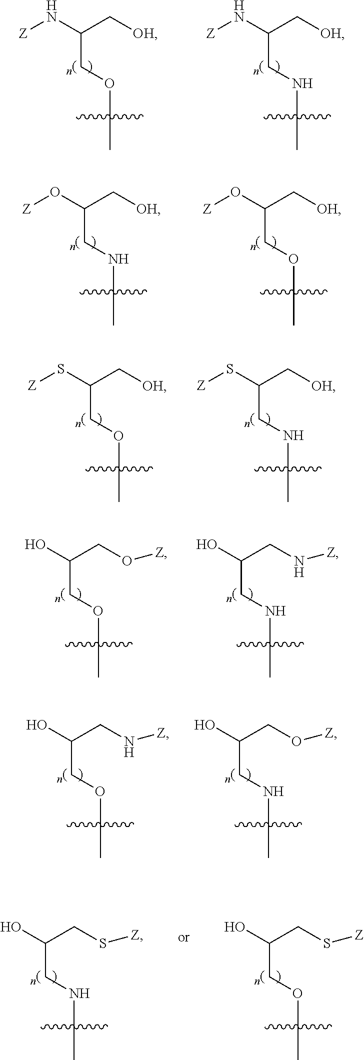

where Z is a separation group and n is 0, 1, 2, 3, 4, 5, 6, 7, 8, 9, or 10. In some embodiments Z is an affinity group.

To form a separation ligand of formula SL2, a series of conjugation reaction precursor compounds are employed, each precursor compound having a reactive handle that is cooperative with the reactive handle of a different precursor compound. In some embodiments, a separation media of formula SL2 is formed through the conjugation of a linker precursor of formula Pre-L, an affinity group precursor of formula Pre-Z(2), and a support substrate precursor of formula Pre-M(2). The linker precursor (Pre-L) includes the spacer Sp of the separation media of formula SL2, a first linker reactive handle Rh³, and a second linker reactive handle Rh⁴. The support substrate precursor (Pre-M(2)) includes a support substrate (vertical black line) and a support substrate reactive handle Rh⁵. The separation group precursor (Pre-Z(2)) includes the separation group Z of formula SL2 and a separation group reactive handle Rh⁶.

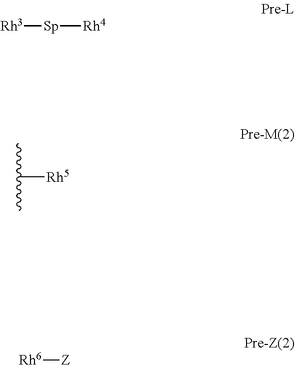

Rh³ and Rh⁵ are a pair of cooperative reactive handles. Rh⁴ and Rh⁶ are a pair of cooperative reactive handles. Rh³ of the linker precursor reacts with Rh⁵ of the support substrate precursor in a conjugation reaction to from a reaction product (i.e., Rp³ of formula SL2). Rh⁴ of the linker precursor reacts with Rh⁶ of the separation group precursor in a conjugation reaction to from a reaction product (i.e., Rp⁴ of formula SL2).

Because the linker precursor includes two reactive handles, the linker precursor is a bifunctional linker. In some embodiments, the linker precursor may be a multifunctional linker precursor that has three or more reactive handles. At least one of the reactive handles is configured to react with the support substrate precursor. The additional reactive handles may be configured to react with a cooperative reactive handle on one or more separation groups. Examples of bifunctional and multifunctional linker precursors include, epichlorohydrin, diglycidyl ether, triglycidyl ether, tetraglycidyl ether, triazine, poly triazine, poly acrylic (e.g., the COOH groups can be made into activated ester reactive handles), succinic acid (e.g., the COOH groups can be made into activated ester reactive handles), glutaraldehyde, divinylsulfone, triazines; anhydrides; disuccinimidyl carbonate (DSC), diisocyanates (e.g., compound having two isocyanate groups).

In some embodiments, a separation ligand of formula SL2 may be formed through two conjugation reactions. The reactions may be conducted in any order or simultaneously. For example, in some embodiments, a separation ligand of formula SL2 is formed by way of synthetic scheme 2 (S2).

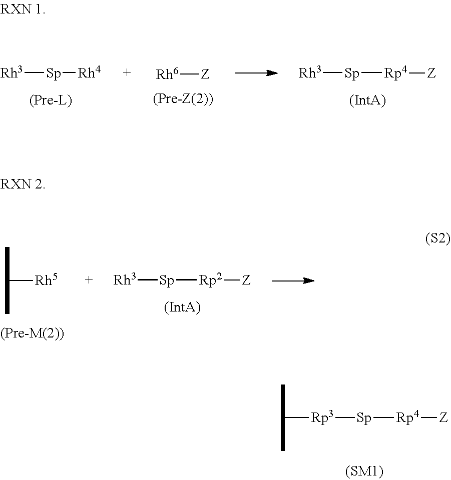

In a first conjugation reaction of scheme S2 (RXN1), the separation group reactive handle (Rh⁶) is reacted with a first linker reactive handle (Rh⁴) in a first conjugation reaction to from a first reaction product Rp⁴ thereby resulting in intermediate A (IntA). Intermediate A is a linker-separation group conjugate that includes the first reaction product (Rp⁴) and the second linker reactive handle (Rh³). IntA may be isolated or taken forward to the second conjugation reaction without isolation. In a second conjugation reaction of S2 (RXN 2) the second linker reactive handle (Rh³) of IntA is reacted with the support substrate reactive handle (Rh⁵) to form a second reaction product (Rp³), thereby forming a separation ligand of formula SL2.

In some embodiments, a separation ligand of formula SL2 is formed by way of synthetic scheme 3 (S3).

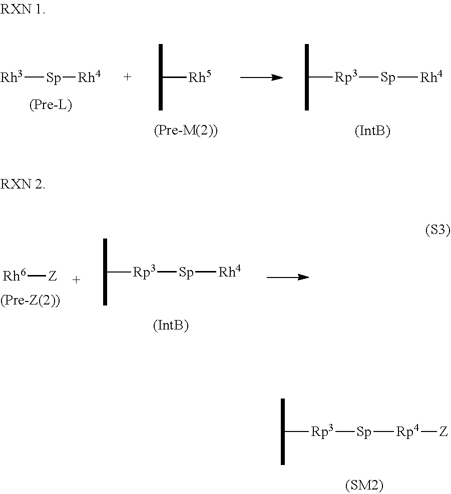

In a first conjugation reaction of scheme S3 (RXN1), the support substrate reactive handle (Rh⁵) is reacted with a first linker reactive handle (Rh³) in a first conjugation reaction to from a first reaction product (Rp³) thereby resulting in intermediate B (IntB). Intermediate B is a linker-support substrate conjugate that includes the first reaction product (Rp³) and the second linker reactive handle (Rh⁴). IntB may be isolated or taken forward to the second conjugation reaction without isolation. In a second conjugation reaction of S3 (RXN 2) the second linker reactive handle (Rh⁴) of IntB is reacted with the separation group reactive handle (Rh⁶) to form a second reaction product (Rp⁴), thereby forming a separation ligand of formula SL2.

Synthetic scheme S4 and synthetic scheme S5 are examples of forming a separation ligand of formula SL2 through scheme S3 using the bifunctional linker (Pre-L) N,N′-disuccinimidyl carbonate (S3) or epichlorohydrin (S4). In both S4 and S5, R¹⁰ can be OH, NH₂, or SH and R¹¹ can be O, NH, or S depending on the identity of R¹⁰.

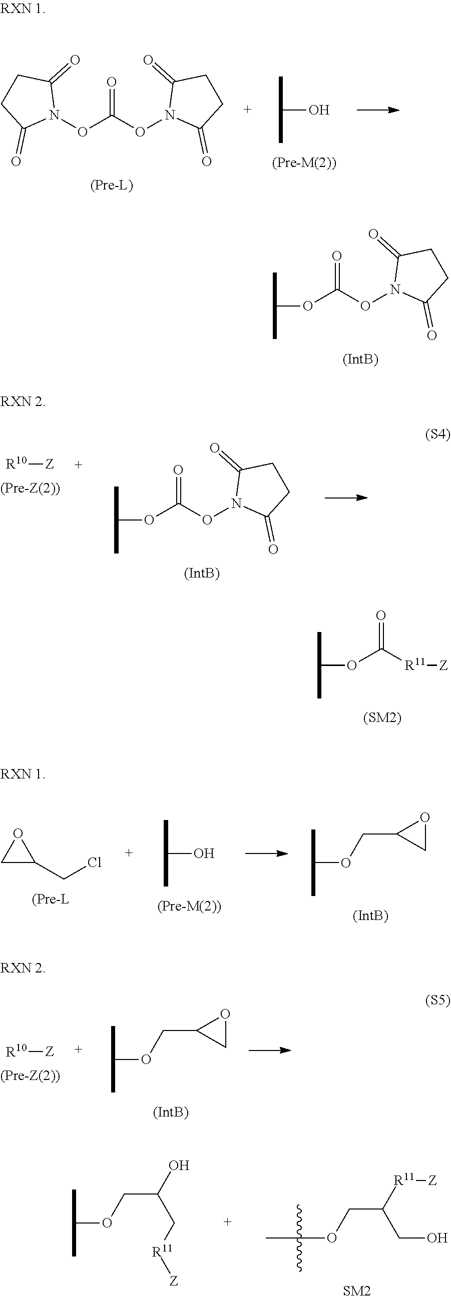

The present disclosure provides methods of making the separation media of the present disclosure. The separation media may be any separation media as disclosed herein. The separation media may be made methods described in PCT application number PCT/US2019/065805 (WO2020123714A1, Zhou), which is incorporated by reference in its entirety.

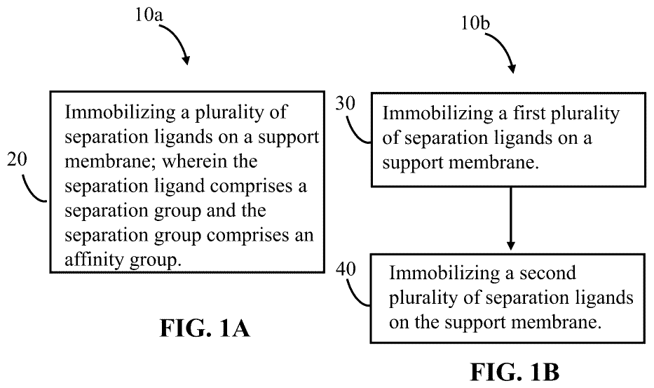

FIG. 1A is a flow diagram depicting a general method 10a for making a separation media of the present disclosure. The general method 10a includes immobilizing a plurality of separation ligands on a support substrate (step 20). Each separation ligand includes a separation group and a linker. The separation media may be of formula SLim. Each separation ligand may be of formula SM, SM1, or SM2. Each separation group can be immobilized according to any relevant synthetic scheme described herein (e.g., S1, S2, S3, S4, or S5).

In some embodiments, the separation media includes a first plurality of separation ligands immobilized on the support substrate and a second plurality of separation ligands immobilized on the support substrate. FIG. 1B is a flow diagram depicting a general method 10b for making a separation media of the present disclosure that includes at least two pluralities of separation ligands. Each plurality of separation ligands immobilized on a support substrate may be of formula SLim. Each separation ligand of the first plurality of separation ligands and the second plurality of separation ligands includes a separation group and a linker. Each separation ligand of the first plurality of separation ligands and the second plurality of separation ligands may be of formula SM, SM1, or SM2. Each separation ligand of the first plurality of separation ligands and the second plurality of separation ligands can be immobilized according to any relevant synthetic scheme described herein (e.g., S1, S2, S3, S4, or S5).

The method 10b includes immobilizing the first plurality of separation ligands on a support substrate (step 30). The method 10b further includes immobilizing the second plurality of separation ligands on the support substrate (step 40).

In some embodiments of method 10b, the first plurality of separation ligands includes an assistance group, and the second plurality of separation ligands includes an affinity group. Without wishing to be bound by theory, it is thought that the assistance groups of the first plurality of separation ligands can interact with (e.g., via electrostatics and/or hydrophobic or hydrophilic interactions) with the affinity group of the separation group precursor used to form the second plurality of separation ligands. Through these interactions, the separation group precursors may be concentrated on the surface of the support substrate thereby increasing conjugation reaction efficiency (e.g., speed and/or yield). An increase in reaction efficiency may allow a lower concentration of the second plurality of separation ligands to be used in the reaction step than would be needed to achieve the same reaction yield and/or surface coverage without the use of assistance groups. In some embodiments, the assistance group includes an amine. In such embodiments where separation ligands that include an amine assistance group are immobilized prior to immobilization of separation ligands containing affinity groups, the method is amine assisted.

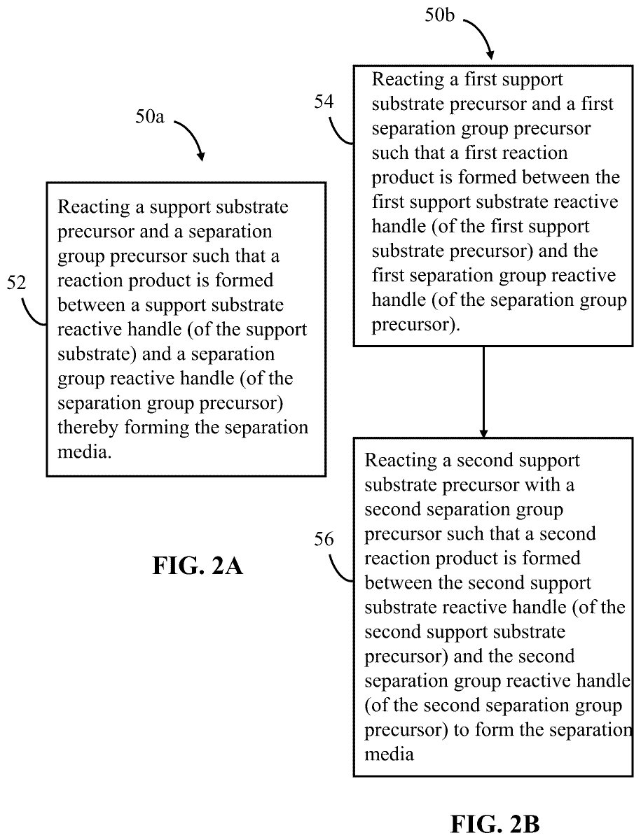

In some embodiments, method 10a or 10b may include method 50a. FIG. 2A is a flow diagram outlining method 50a for making a separation media including a separation ligand of the present disclosure. Method 50a may be understood in reference to synthetic scheme S1 as described herein; however, it is understood that method 50a is not limited to the synthetic scheme S1. The separation ligand of the separation media made from method 50a is synthesized from two components, a separation group precursor (e.g., Pre-Z(1)) and a support substrate precursor (e.g., Pre-M(1)). The separation group precursor includes the separation group (Z) and a separation group reactive handle (Rh²). The support substrate precursor includes a support substrate (thick vertical black line) and a support substrate reactive handle (Rh¹). The separation group reactive handle and the support substrate reactive handle are cooperative handles. Method 50a includes reacting a support substrate precursor and a separation group precursor such that a reaction product (e.g., Rp¹) is formed between the support substrate reactive handle (of the support substrate precursor) and the separation group reactive handle (of the separation group precursor) thereby forming the separation media (e.g., the immobilized separation ligand of Formula SLim.

In some embodiments, step 52 may be accomplished using a reaction mixture. The reaction mixture includes a solvent and the separation group precursor. The reaction mixture may be applied to the support substrate, or the support substrate may be submerged in the reaction mixture. The solvent may include an organic solvent, water, or both. In some embodiments, the solvent is an aqueous buffer that includes one or more salts and/or buffering agents as disclosed herein. The reaction mixture may include additional compounds that facilitate the reaction. For example, the reaction mixture may include an acid, a base, an initiator, a catalyst, or any combination thereof.

In some embodiments where the solvent includes an organic solvent, the reaction step is considered to be “organic assisted” or “organic solvent assisted.” In an organic assisted method, the solvent of the reaction mixture includes water and at least one water-miscible organic solvent. Examples of water-miscible organic solvents include ethanol, acetone, acetonitrile, methanol, propanol (e.g., 2-propanol, 1-propanol), 2-butanol, tetrahydrofuran, dimethylformamide, and dimethyl sulfoxide. The ratio of water to organic solvent in the reaction mixture is such that the reaction mixture is at or near the cloud point of the mixture. The cloud point is the point at which a liquid solution undergoes a liquid-liquid phase separation to from an emulsion or a liquid-solid phase transition to form a stable suspension or a precipitate. The cloud point can be visualized by observing the water-to-organic solvent ratio at which the reaction solution becomes turbid. Without wishing to be bound by theory, it is thought that including an organic solvent in the reaction mixture such that the reaction mixture is at or near the cloud point increases the conjugation reaction efficiency. The organic solvent molecule can displace water molecules in the separation group precursor thereby increasing interactions between the separation group precursor and the support substrate. In embodiments, the organic assisted method can be used when the affinity group includes a peptide (e.g., an anti-epitope antibody, an anti-epitope antibody fragment, an anti-epitope antibody mimetic, or a ligand tag binding peptide).

It is possible to define a range of appropriate amounts of organic solvent in the reaction solution in which the upper boundary is expressed by [V %_{cp}+a(100%−V %_{cp})] and the lower boundary is expressed by [V %_{cp}−bV %_{cp}], where “V %_{cp}” is the percent by volume of the organic solvent in the reaction mixture at the cloud point, “a” is the upper deviation from the cloud point, and “b” is the lower deviation from the cloud point. For the purpose of an example, if the percent by volume of the organic solvent in the ligand solution at the cloud point (V %_{cp}) is 60%, and the upper and lower boundaries are defined by a=0.3 and b=0.5, then the corresponding appropriate amounts of organic solvent in the reaction mixture would range from 30% to 72% organic solvent by volume. In embodiments, the reaction mixture can include amount of organic solvent in which “a” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, or 0.99 and “b” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, or 0.99. In some embodiments, the reaction mixture includes an amount of organic solvent ranging from 70% to 130%, 80% to 120%, 90% to 110%, or 95% to 105% of the volumetric amount of the organic solvent at the cloud point of the reaction mixture.

In some embodiments where the reaction mixture is aqueous and includes one or more salts, the reaction step may be kosmotropic salt assisted. In a kosmotropic salt assisted method, the reaction mixture includes water and at least one kosmotropic salt at a concentration such that the reaction mixture is at or near its cloud point. Examples of kosmotropic salts include sodium phosphate, sodium sulfate, and ammonium sulfate. Without wishing to be bound by theory, it is thought that including kosmotropic salts in the reaction mixture such that the reaction mixture is at or near the cloud point increases the conjugation reaction efficiency. The salt molecules can disrupt the solvation shell of separation group precursors thereby increasing interactions between the separation group precursor and the support substrate.

In some embodiments, the separation media includes a first plurality of separation ligands immobilized on the support substrate and a second plurality of separation ligands immobilized on the support substrate. In some such embodiments, method 50b may be used to prepare the separation media. FIG. 2B is a flow diagram outlining method 50b for making a separation media that includes multiple pluralities of separation ligands immobilized to the support substrate. The first plurality of separation ligands synthesized according to method 50b are made from two components, a first support substrate reactive precursor and a first separation group precursor. The second plurality of separation ligands synthesized according to method 50b are made from two components a second support substrate reactive precursor and a second separation group precursor. The first support substrate precursor includes the first support substrate reactive handle. The second support substrate precursor includes a second support substrate reactive handle. The first support substrate reactive handle and the second support substrate reactive handle may be the same or different. The first separation group precursor includes a separation group and a first separation group reactive handle. The second separation group precursor includes a separation group and the second separation group reactive handle. The first support substrate reactive handle and the first separation group reactive handle are cooperative reactive handles. The second support substrate reactive handle and second separation group reactive handle are cooperative handles.

Method 50b includes reacting the first support substrate precursor and the first separation group precursor such that a first reaction product is formed between the first support substrate reactive handle (of the first support substrate precursor) and the first separation group reactive handle (of the first separation group precursor). The method further includes reacting the second support substrate precursor with the second separation group precursor such that a second reaction product is formed between the second support substrate reactive handle (of the second support substrate precursor) and the second separation group reactive handle (of the second separation group precursor).

In some embodiments, the first separation group precursor includes an amine, and the entire method (50b) is amine assisted.

In some embodiments, step 54, step 56, or both are organic solvent assisted or kosmotropic salt assisted. For example, step 54 may be accomplished with a first reaction mixture that includes the first separation group precursor, water, and an organic solvent that is miscible with water or a kosmotropic salt. Step 56 may be accomplished with a second reaction mixture. The second reaction mixture includes the second separation group precursor water and an organic solvent that is miscible with water or at least one kosmotropic salt.

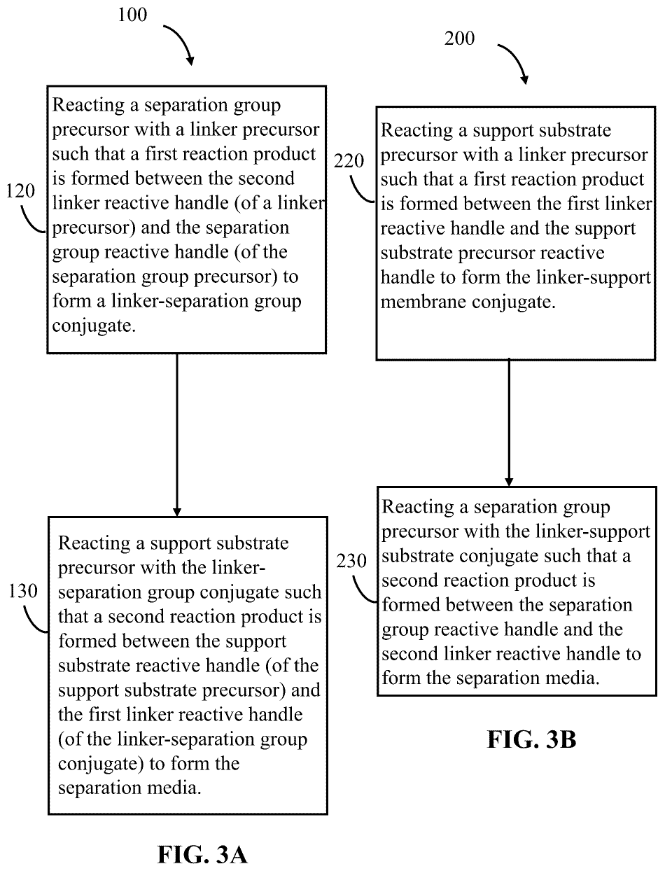

In some embodiments, method 10a, 10b, 50a, or 50b may include method 100. FIG. 3A is a flow diagram outlining method 100. Method 100 may be understood in reference to synthetic scheme S2 as described herein; however, it is understood that the method of 100 is not limited to the synthetic scheme S2. The separation ligands of the separation media made according to method 100 are synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

The method 100 includes reacting the separation group precursor with the linker precursor such that a first reaction product is formed between the second linker reactive handle (of a linker precursor) and the separation group reactive handle (of the separation group precursor) to form a linker-separation group conjugate (step 120; IntA). Method 100 further includes reacting the support substrate precursor (Pre-M(2)) with the linker-separation group conjugate of step 120 such that a second reaction product is formed between the support substrate reactive handle (of the support substrate precursor) and the first linker reactive handle (of the linker-separation group conjugate) to form the separation media (step 130).

In some embodiments, method 10a, 10b, 50a, or 50b may include the method 200. FIG. 3B is a flow diagram outlining method 200. The method 200 may be understood in reference to synthetic scheme S3 as described herein; however, it is understood that the method of 200 is not limited to the synthetic scheme S3. The separation ligand made according to method 200 is synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

Method 200 includes reacting a support substrate precursor with a linker precursor such that a first reaction product is formed between the first linker reactive handle and the support substrate precursor reactive handle to form the linker-support substrate conjugate (IntB). Method 200 further includes reacting a separation group precursor (Pre-Z(2)) with the linker-support substrate conjugate (IntB) such that a second reaction product (Rp⁴) is formed between the separation group reactive handle (Rh⁶) and the second linker reactive handle (Rh⁴) to form the separation media.

Any step of method 100 or method 200 may be organic solvent assisted or kosmotropic salt assisted.

In some embodiments, methods 10a, 10b, 50a, 50b, 100, and 200 further include functionalizing the support substrate to install the support substrate reactive handles. Installing the support substrate reactive handles followed by one or more conjugation reactions to immobilize the separation ligands to the reactive handles is called indirect immobilization. In such embodiments, the method may further include depositing a polymer having reactive handles onto the support substrate. In some embodiments, the polymer is deposited such that is grafted onto the support substrate. In other embodiments, the polymer is deposited such that it is grafted from the support substrate. In embodiments where the polymer is grafted from the support substrate, the method may further include coupling an initiator to the support substrate to form an immobilized initiator. In such embodiments, the method may further include polymerizing a plurality of monomers from the immobilized initiator.

In some embodiments, the support substrate reactive handle is already a part of the support substrate and not from a deposited functional layer. In such embodiments, the separation ligands are immobilized directly to the support substrate in a process called direct immobilization. Any of the methods 10a, 10b, 50a, 50b, 100, and 200 may include direct immobilization.

Direct and indirect immobilization may be accomplished using the amine assisted method, without amine assistance groups (not amine assisted), using the organic solvent assistance method, using the kosmotropic assisted method, not using the kosmotropic salt assisted method, or any combination thereof.

In some embodiments, the methods of 10a, 10b, 50a, 50b, 100, and 200 include swelling the support substrate prior to any one of the conjugation steps. Swelling the support substrate includes exposing the support substrate to a swelling mixture. The swelling mixture includes one or more organic solvents. Examples of organic solvent that may used in a swelling mixture include dimethyl sulfoxide, acetonitrile, tetrahydrofuran, dimethylformamide, hexamethylphosphoramide, ionic liquids, sulfolane, or any combination thereof.

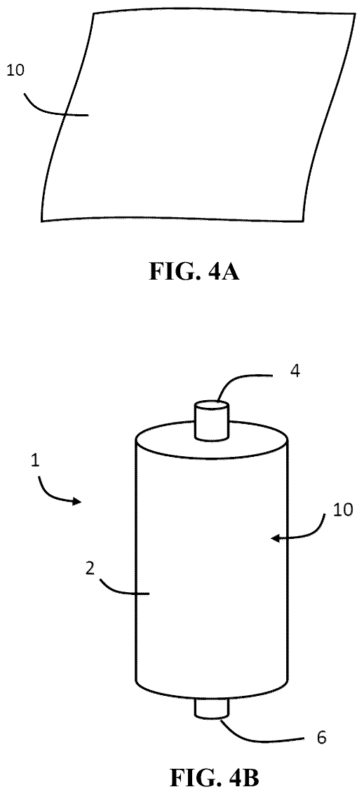

The separation media of the present disclosure may be employed in a separation device. The separation device is a membrane chromatography column, a membrane chromatography cassette, or other membrane chromatography device that includes the separation media of the present disclosure. A separation device may be operated manually or integrated with software, pumps, detectors, and/or other accessories. The separation media 10 is schematically shown as a membrane in FIG. 4A. The separation media membrane 10 may be provided in a separation device 1 (e.g., a chromatography column), shown in FIG. 4B. The separation device 1 includes a housing 2 with an inlet 4 and an outlet 6 to facilitate flow through the device.

In some embodiments, two or more separation media of the present disclosure may be arranged in a stacked configuration. The stacked configuration may be employed in a separation device. In some embodiments, a first separation media and a second separation media are arranged in a stacked configuration. In some embodiments, the first separation media and the second separation media have the same identity; that is, the separation media have the same support substrate and the same separation ligands immobilized on the substrate. The separation ligands are immobilized at the same or similar separation ligand densities. In other embodiments, the first separation media and the second separation media have different identities. For example, the first separation media and the second separation media have a different support substrate; different separation ligands; different separation group densities; or any combination thereof.

The separation device (e.g., membrane chromatography column, membrane chromatography cassette, or other membrane chromatography device) may provide a residence time of 5 minutes or less, 2 minutes or less, 1 minute or less, 30 seconds or less, 10 seconds or less, 6 seconds or less, 5 seconds or less, 4 seconds or less, 3 seconds or less, 2 seconds or less, or 1 second or less. The separation device (e.g., membrane chromatography column, membrane chromatography cassette, or other membrane chromatography device) may provide a residence time of 0.01 seconds or greater, 0.1 seconds or greater, 1 second or greater, 5 seconds or greater, 6 seconds or greater, 10 seconds or greater, 30 seconds or greater, 1 minute or greater, or 2 minutes or greater. Residence time is the time any normalized amount of fluid takes to traverse the separation media of the separation device (a single separation media or multiple separation media). For example, residence time is the time it takes any molecule that is not the target and/or does not bind to the separation media to traverse the separation media in a separation device. Residence time is calculated as the flow rate or the solution going through the column divided by the total bed volume of all of the separation media included in the separation device. The residence times of the separation devices of the present disclosure may be lower than those of separation media made of resins.

Process productivity can be defined using the equation below. In the denominator, Vₜₒₜ is the total volume of solution passing through the separation media (e.g., column or cassette) during the whole process, including load (the volume of the isolation solution discussed herein), rinse (e.g., the volume of the washing solution as discussed herein), elution (e.g., the volume of the elution solution as discussed herein), and regeneration steps (e.g., the volume of the regeneration solution as discussed herein). BV is the chromatography medium bed volume (corresponding to the volume of the separation media), and tau is residence time of the target. Loading volume is proportional to dynamic binding capacity of the chromatography column medium. Thus, process productivity increases with increasing binding capacity and decreasing residence time.

$$Productivity = \frac{target}{Cost of time} = \frac{Loading volume \times target \times yield}{( \frac{{V}_{tot}}{BV} ) \times τ}$$

Dynamic binding capacity generally refers to the concentration of bound target on the separation media (milligram bound per unit bed volume of separation media) at breakthrough in the effluent. A dynamic binding capacity at 10% breakthrough (DBC_{10%}) can be determined via a standard chromatography method, e.g., using Cytiva ÄKTA pure Fast Protein Liquid chromatography (FPLC). First, the separation media is packed into a housing unit. Then, the contained separation media is connected to an FPLC system. Next, feed material (e.g., isolation solution) containing the target is passed though the separation media under certain column volumes per minute flowrate (CV/min) until the effluent concentration of the target reaches 10% of the feed concentration, as determined by a detector (e.g., a UV detector). At the end, based on the holdup volume in the FPLC system and separation media volume, the DBC_{10%} is calculated as follows ((Volume to 10% breakthrough-holdup volume)×(feed concentration))/(volume of separation media)=DBC_{10%} expressed as mg target material/unit volume separation media. The volume of the separation media is determined by the surface area of the separation media multiplied by the thickness of the separation media. The volume of the separation media can be referred to as the bed volume. In general, the volume of the separation media does not account for the void space within the separation media. The holdup volume is the total volume between the injection port (i.e., the location where a fluid enters the system) and the detector. The holdup volume includes the bed volume (e.g., the separation media volume) as well as any volume between the injection port and the bed and any volume between the bed and the detector.

In some embodiments, a separation media or separation device containing the same has a dynamic binding capacity at 10% breakthrough of 0.01 milligrams of target per 1 mL bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media has a dynamic binding capacity at 10% breakthrough of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a dynamic binding capacity at 10% breakthrough of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/ml bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The dynamic binding capacity may depend at least in part on the target and the affinity group.

The separation media of the present disclosure may have a variety of static binding capacities (SBC). The static binding capacity is the amount of target bound to the separation media per volume of the separation media. The static binding capacity can be determined, for example, by incubating the separation media with an isolation solution containing a known amount of the target ligand for a period of time. Following incubation, the amount of the target still in the isolation solution (target not bound to the separation media) can be measured. The static binding capacity can then be calculated as the difference between the initial amount of the target in the isolation solution and the amount of target in the isolation solution following incubation with the separation media. The amount of the target in the isolation solution pre- and post-incubation with the separation media can be determined, for example, using spectroscopy and/or high performance liquid chromatography.

The static binding capacity may be higher than the dynamic binding capacity at 10% breakthrough. For example, in some embodiments, the SBC can be 10% to 40% greater than the DBC_{10%}. The pore size of the support substrate may influence the SBC and DBC_{10%}. For example, smaller pore sizes may cause a greater difference between the SBC and the DBC_{10%} as compared to relatively larger pore sizes. In some embodiments, a separation media or separation device containing the same has a static binding capacity of 0.01 milligrams of target per 1 mL of bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media or separation device containing the same has a static binding capacity of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a static binding capacity of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/ml bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The static binding capacity may depend at least in part on the target and the affinity group.

The separation media may have a variety of separation ligand densities. Separation ligand density is the amount of separation ligands immobilized per unit volume of the separation media. In embodiments where the separation media only includes separation groups that include affinity groups, the separation group density can be a measure of affinity group density. The separation ligand density can be determined, for example, by incubating the support substrate (for example, according to S1, S2, or S3) with the reaction solution containing a known amount of the separation group precursor for immobilization for a reaction time to form the separation media. Following incubation, the amount of the separation group precursor containing still in the reaction solution (unreacted) can be measured. The density of the separation ligands can then be calculated as the difference between the initial amount of the separation group precursor in the reaction solution and the amount of separation group precursor in the reaction solution following incubation with the support substrate. The amount of the separation group precursor in the reaction solution pre- and post-incubation with the support substrate can be determined, for example, using spectroscopy and/or high performance liquid chromatography. The separation group pre-cursor can be used as a proxy for the separation ligand.

In some embodiments, the separation media has separation ligand density of 0.01 milligrams of separation ligands per 1 mL of bed volume (mg/mL bed volume) or greater, 0.1 mg/mL bed volume or greater, 1 mg/mL bed volume or greater, 5 mg/mL bed volume or greater, 10 mg/mL bed volume or greater, 20 mg/mL bed volume or greater, 30 mg/mL bed volume or greater, 40 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, 110 mg/mL bed volume or greater, or 120 mg/mL bed volume or greater. In some embodiments, a separation media has a separation ligand density of 150 mg/mL bed volume or less, 120 mg/mL bed volume or less, 110 mg/mL bed volume or less, 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 30 mg/mL bed volume or less, or 20 mg/mL bed volume or less, 10 mg/mL bed volume or less, 5 mg/mL bed volume or less, 1 mg/mL bed volume or less, or 0.1 mg/mL bed volume or less. In some embodiments, a separation media has a separation ligand density of 0.01 mg/mL bed volume to 150 mg/mL bed volume, 0.1 mg/mL bed volume to 150 mg/mL bed volume, 1 mg/mL bed volume to 150 mg/ml bed volume, 5 mg/mL bed volume to 150 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 10 mg/mL bed volume to 20 mg/mL bed volume, 15 mg/mL bed volume to 60 mg/mL bed volume, 15 mg/mL bed volume to 50 mg/mL bed volume, 15 mg/mL bed volume to 30 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 20 mg/mL bed volume to 30 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, or 1 mg/mL bed volume to 10 mg/mL bed volume.

Separation ligand density can also be described as the specific surface area (SSA) in square meters (m²) relative to the bed volume of the separation media. SSA can be determined, for example, using nitrogen Brunauer-Emmett-Teller (BET) analysis. Prior to immobilization of the separation ligands on the support substrate, the support substrate will have a support substrate SSA. After immobilization of the separation ligands on the support substrate to form the separation media, the separation media has a separation media SSA. The support substrate SSA and the separation media SSA may be impacted by the pore size of the support substrate, Generally, support substrates with greater pore sizes have a larger support substrate SSA. Generally, the separation media SSA will be greater than the support substrate SSA. In some embodiments the separation media SSA is 0.5 times or greater than the support substrate SSA, 1 time or greater than the support substrate SSA, 1.5 times or greater than the support substrate SSA, 2 times or greater than the support substrate SSA, 3 time or greater than the support substrate SSA, 4 time or greater than the support substrate SSA, 5 time or greater than the support substrate SSA, or 7 time or greater than the support substrate SSA. In some embodiments the separation media SSA is 10 times or less than the support substrate SSA, 7 times or less than the support substrate SSA, 5 times or less than the support substrate SSA, 4 times or less than the support substrate SSA, 3 times or less than the support substrate SSA, 2 times or less than the support substrate SSA, 1.5 times or less than the support substrate SSA, or 1 time or less than the support substrate SSA.

In some embodiments the separation media has a separation SSA of 1.5 meters squared per milliliter of bed volume (m²/mL bed volume) or greater, 2 m²/mL bed volume or greater, 3 m²/mL bed volume or greater, 4 m²/mL bed volume or greater, 5 m²/mL bed volume or greater, 8 m²/mL bed volume or greater, 9 m²/mL bed volume or greater, 10 m²/mL bed volume or greater, or 15 m²/mL bed volume when the support substrate has an average pore size of 0.1 micrometers to 10.0 micrometers, such as 0.2 micrometers to 0.5 micrometers. In some embodiments the separation media has a separation SSA of 20 m²/mL bed volume or less, 15 m²/mL bed volume or less, 10 m²/mL bed volume or less, 9 m²/mL bed volume or less, 8 m²/mL bed volume or less, 7 m²/mL bed volume or less, 6 m²/mL bed volume or less, 5 m²/mL bed volume or less, 4 m²/mL bed volume or less, or 3 m²/mL bed volume or less, 2 m²/mL bed volume or less when the support substrate has an average pore size of 0.1 micrometers to 10.0 micrometers, such as 0.2 micrometers to 0.5 micrometers. In some embodiments the separation media has a separation SSA of 1.5 m²/mL bed volume to 20 m²/mL bed volume, 1.5 m²/mL bed volume to 15 m²/mL, 1.5 m²/mL bed volume to 10 m²/mL, 2 m²/mL bed volume to 20 m²/mL, 2 m²/mL bed volume to 15 m²/mL, 2 m²/mL bed volume to 10 m²/mL, 2 m²/mL bed volume to 9 m²/mL, 2 m²/mL bed volume to 8 m²/mL, 2 m²/mL bed volume to 7 m²/mL, 2 m²/mL bed volume to 6 m²/mL, 2 m²/mL bed volume to 5 m²/mL, 3 m²/mL bed volume to 20 m²/mL, 3 m²/mL bed volume to 15 m²/mL, 3 m²/mL bed volume to 10 m²/mL, 4 m²/mL bed volume to 20 m²/mL, 4 m²/mL bed volume to 15 m²/mL, 4 m²/mL bed volume to 10 m²/mL, 5 m²/mL bed volume to 20 m²/mL, 5 m²/mL bed volume to 15 m²/mL, or 5 m²/mL bed volume to 10 m²/mL when the support substrate has an average pore size of 0.1 micrometers to 10.0 micrometers, such as 0.2 micrometers to 0.5 micrometers.

In some embodiments, the separation media and/or separation devices containing the same are able to purify a target at fast flow rates. For example, separation media and/or separation devices containing the same may be used to purify a target at residence times of 5 minutes or less, 2 minutes or less, 1 minute or less, 30 seconds or less, 10 seconds or less, or 6 seconds or less. The residence time is somewhat dependent on the volume of the separation media and/or on the size of the device. For example, in separation media that have low volumes and/or separation devices that are small, the residence times may be as low as 1 second or less. Although there is no desired lower limit for the residence time, in practice residence times are 0.1 seconds or greater.

In some embodiments, the separation media and/or separation device containing the same may be used to purify or concentrate a target from an isolation solution with a high recovery of the target molecule. The recovery of a target molecule is amount of the target molecule recovered after passing it through the separation media divided by the amount of target molecule in the isolation solution. In some embodiments, the target molecule recovery is 50% or greater, 60% or greater, 80% or greater, 90% or greater, 95% or greater, or 99% or greater. In some embodiments, the target molecule recovery is 100% or less, 95% or less, 90% or less, 80% or less, 70% or less, or 60% or less. In some embodiments, the target molecule recovery is 80% to 100%, 90% to 100%, or 95% to 100%.

In some embodiments, the separation media and/or separation device containing the same may be used to purify or concentrate target models from an isolation solution with a high recovery of active target molecule. An active target molecule is a molecule that possesses at least some of the function as the target molecule prior to exposure to the separation media of the present disclosure. For example, an active target molecule is a target molecule that has undergone purification using the separation media of the present disclosure and retains at least some binding affinity to a binding partner. The recovery of active target molecules is the amount of active target molecule recovered after passing them through the separation media divided by the amount of target molecules in the isolation solution. In some embodiments, the active target molecule recovery is 50% or greater, 60% or greater, 80% or greater, 90% or greater, 95% or greater, or 99% or greater. In some embodiments, the active target molecule recovery is 100% or less, 95% or less, 90% or less, 80% or less, 70% or less, or 60% or less. In some embodiments, the active target molecule recovery is 80% to 100%, 90% to 100%, or 95% to 100%.

In some embodiments, the separation media and/or separation device containing the same may be used to remove impurities from an isolation solution. An impurity is any molecule that is not the target molecule, or a buffering agent, a salt, or an additive that has been added to the isolation solution. In some embodiments, the separation media can remove 50% or greater, 60% or greater, 70% or greater, 80% or greater, 90% or greater, or 99% or greater of the impurities initially present in the isolation solution. In some embodiments, the separation media can remove 100% or less, 99% or less, 90% or less, 80% or less, 70% or less, or 60% or less. In some embodiments, the separation media can remove 50% to 100%, 60% to 100%, 70% to 100%, 80% to 100%, 90% to 100%, 90% to 99%, or 90% to 95% of the impurities initially present in the isolation solution.

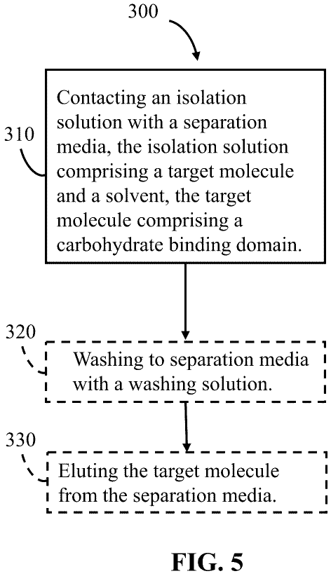

The present disclosure describes a method for using the separation media and/or the separation devices of the present disclosure. FIG. 5 is a flow diagram outlining a method 200 for using the separation media of the present disclosure to isolate and/or concentrate a target molecule from an isolation solution. Method 300 includes contacting an isolation solution with a separation media (step 310).

The isolation solution includes a solvent and a target molecule (e.g., a plurality of targets). In some embodiments, the isolation solution includes a plurality of target molecules that have already been purified from a mixture that included additional biomolecules. In some such embodiments the plurality of target molecules may be already pure but not concentrated to the desired concentration in a given isolation solution. In such embodiments, the separation media may be used to concentrate the plurality of target molecules by decreasing the volume of solution in which they are located. In such embodiments, the isolation solution may include one or more suitable buffering agents, one or more suitable salts, one or more suitable additives, or any combination thereof.

In other embodiments, the separation media or separation device may be used to purify the target from a mixture that includes contaminant molecules or undesired molecules. In some such embodiments, the isolation solution includes a mixture of biomolecules and/or cellular debris. In addition, the isolation solution may include one or more suitable buffering agents, suitable salts, other suitable additives, or any combination thereof. For example, the isolation solution may include the lysate of an expression system used to produce the plurality of target molecules as well as any salts, buffering agents, or additives used to lyse the cells. The isolation solution may include the media (e.g., Dulbecco's modified eagle medium) of an expression system in which the target molecules have been made. The isolation solution may include the reaction components of a reaction used to make the target molecules.

Examples of suitable salts and buffering agents include sodium chloride; potassium chloride; lithium chloride; rubidium chloride; calcium chloride; magnesium chloride; cesium chloride; tris base (tris(hydroxymethyl)aminomethane); 4-(2-hydroxyethyl)-1-piperazineethanesulfonic acid (HEPES); sodium phosphate; potassium phosphate; ammonium sulfate, 2-(N-morpholino)ethanesulfonic acid (MES); 2,2′,2″-nitrilotriacetic acid (ADA); N-(2-acetamido)-2-aminoethanesulfonic acid (ACES); 3-morpholino-2-hydroxypropanesulfonic acid (MOPSO); cholamine chloride hydrochloride; 3-(N-morpholino) propanesulfonic acid (MOPS); N,N-bis(2-hydroxyethyl)-2-aminoethanesulfonic acid (BES); 2-{[1,3-Dihydroxy-2-(hydroxymethyl)propan-2-yl]amino}ethane-1-sulfonic acid (TES); 3-(N,N-Bis [2-hydroxyethyl]amino)-2-hydroxypropanesulfonic acid (DIPSO); 3-[N-tris(hydroxymethyl)methylamino]-2-hydroxypropanesulfonic acid (TAPSO); acetamidoglycine; piperazine-1,4 bis(2-hydroxypropanae sulphonic acid) (POPSO); N-(hydroxyethyl) piperazine-N′-2-hydroxypropanesulfonic acid (HEPPSO); 3-[4-(2-hydroxyethyl) piperazin-1-yl]propane-1-sulfonic acid (HEPPS); N-(tri(hydroxymethyl)methyl)glycine (tricine); 2-aminoacetamide; glycylglycine; N,N-bis(2-hydroxyethyl)glycine; N-tris(hydroxymethyl)methyl-3-aminopropanesulfonic acid (TAPS); and the like. Suitable salts and/or buffering agents may be added in an amount of 1 millimolar (mM) or greater, 5 mM or greater, or 10 mM or greater, 20 mM or greater, 50 mM or greater, 100 mM or greater 200 mM or greater, or 500 mM or greater. Suitable salts may be added in an amount of 1 M or less, 500 mM or less, 100 mM or less, 50 mM or less, or 30 mM or less. The salts may be added in an amount ranging from 1 mM to 1 M, 1 mM to 500 mM, 1 mM to 200 mM, 1 mM to 100 mM, 1 mM to 50 mM, 5 mM to 30 mM, 5 mM to 20 mM, or 20 mM to 100 mM.

In some embodiments, the isolation solution includes one or more kosmotropic salts, one or more chaotropic salts, or both. Kosmotropic salts are known as salts that decrease the solubility of nonpolar substances in aqueous solutions. In contrast, chaotropic salts increase the solubility of nonpolar substances in aqueous solutions. In some embodiments, the amount and/or identity of a kosmotropic and/or chaotropic salts may be designed to increase the binding affinity and/or binding specificity between the target molecules and the affinity groups and/or assistance groups (if present).

Examples of kosmotropic salts that may be present in the isolation solution include ammonium sulfate, ammonium phosphate, potassium phosphate, sodium sulfate, sodium chloride, and any combination thereof. Suitable kosmotropic salts may be present in the isolation solution in an amount of 0.1 M or greater, 0.5 M or greater, or 1.0 M or greater, or 2.0 M or greater. Suitable kosmotropic salts may be present in the isolation solution in an amount of 6.0 M or less, 5.0 M or less, or 4.0 M or less. The kosmotropic salts may be added in an amount ranging from 0.1 M to 6M, 0.5 M to 2.5 M, or 0.5 M to 3.0 M.

Examples of chaotropic salts that may be present in the solution include sodium chloride, calcium chloride, magnesium chloride and any combination thereof. In some embodiments, the isolation solution includes 1 M or less, 0.5 M or less, or 0.1 M or less of chaotropic salts. In some embodiments, the isolation solution is free or substantially free of chaotropic salts.

Suitable additives include glycerol and other polyols; protease inhibitors; phosphatase inhibitors; cryoprotectants; detergents; chelating agents; reducing agents; and any combination thereof. Suitable additives may be present in the isolation solution in amounts of 0.01 mM or greater, 0.1 mM or greater, 1 mM or greater, 5 mM or greater, 10 mM or greater, or 20 mM or greater. Suitable salts may be added in an amount of 100 mM or less, 50 mM or less, 30 mM or less, 10 mM or less, 5 mM or less, or 1 mM or less. Suitable additives may be present in the isolation solution in amounts ranging from 0.01 mM to 100 mM, 1 mM to 50 mM, 5 mM to 30 mM, 5 mM to 20, 0.01 mM to 5 mM, or 1 mM to 5 mM.

The isolation solution solvent may be any solvent that does not degrade or react with the target molecule. In some embodiments, the solvent includes water, an organic solvent, or both. In some embodiments, the solvent includes an organic solvent such as, for example, methanol, ethanol, isopropanol, and acetonitrile, DMSO, DMF, or any combination thereof. In some embodiments, the majority of the solvent is water. Alternatively, in some embodiments, the majority of the solvent may be made up of organic solvents. In some embodiments, the solvent is nonaqueous, e.g., consists of organic solvents.

The pH of the isolation solution may be any pH that does not make the target molecule unstable or insoluble. Additionally, the pH of the isolation solution should be such that the separation ligands of the separation media are not unstable. The pH of the isolation solution may be controlled to enhance the binding affinity of the target molecules to the affinity groups and/or assistance group (if present).

The isolation solution is contacted with the separation media such that at least a portion of the plurality of the target molecules bind to at least a portion of the separation ligands that include an affinity group and/or an assistance group (if present). Molecules present in the solution that have a lower affinity for the dye containing separation groups than the target molecules include a will not bind to the affinity group or will bind to the affinity group with a lesser affinity than the target molecule. Such off target molecules can be removed in a washing step as discussed herein. Through binding to the affinity group, the target molecules are temporarily immobilized on the support substrate.

In some embodiments, the method 300 includes washing the separation media with a washing solution (step 320). Washing the separation media with a washing solution includes contacting the separation media with the washing solution. Washing the separation media may allow for any molecules that are not the target molecule to be removed from the separation media. In the washing step, at least a portion of the target molecules remain bound to the affinity group and temporarily immobilized on the support substrate.

The washing solution may include a variety of components or may simply be a solvent (e.g., water). The composition and/or pH of the washing solution should be such that none of the components degrade or react with the target molecule. Additionally, the composition and/or pH should be such that the washing solution does not decrease the affinity of the target molecule to the affinity group to a point where the target molecule is able to be removed from the affinity group and washed through the separation media. The washing solution includes a washing solvent. The washing solvent may be water, an organic solvent, or both. The washing solvent may be any solvent as described herein such as those described relative to the isolation solution. In embodiments, the washing solution includes one or more buffering agents, one or more salts, one or more additives, or any combination thereof. In some embodiments, the one or more salts, one or more buffering agents, or one or more additives may be present in the washing solution in any amount as described relative to the isolation solution.

The pH of the washing solution may be any pH that does not make the target molecule unstable or insoluble. Additionally, the pH of the washing solution should be such that the separation ligands of the separation media are not unstable. The pH of the washing solution may be controlled to enhance the binding affinity of the target molecules to the affinity groups and/or decrease the binding affinity of any off target molecules to the affinity groups.

In some embodiments, step 320 may be repeated with additional washing solutions. The additional washing solutions may have the same composition and/or pH as the first washing solution or a different composition and/or pH than the first washing composition.

In some embodiments, method 300 further includes eluting the plurality of target molecules that were temporarily immobilized on the support substrate (step 330). The target molecules may be eluted by contacting the separation media with an elution solution. The elution solution includes an elution solvent. The elution solvent may be any solvent as described herein (e.g., the solvent included in the washing solution and/or the isolation solution). The elution solution may be of any composition and/or pH that allows for the target molecules to be separated from the affinity groups and exit the separation media.

In some embodiments, the elution solution may include a molecule that is recognized and bound by the affinity group, the target molecule, and/or can compete for binding to the affinity group or target molecule. Such a molecule may be present in an amount such as to compete off the target molecule from an affinity group. To that end, in some embodiments, the elution solution includes an affinity group competitive molecule and the elution solvent. Different target molecules (or target molecules and other molecules) may be eluted using a linear gradient elution or using a step isocratic elution.

An affinity group competitive molecule is a molecule that binds to the affinity group, and when present at a sufficient concentration can compete off the target molecule from the affinity group. In some embodiments, the affinity group competitive molecule has a higher affinity for the affinity group than the target molecule. In other embodiments, the affinity group competitive molecule has a lower affinity for the affinity group than the target molecule. In yet other embodiments, the affinity group competitive molecule may have the same affinity for the affinity group as the target molecule.

An affinity group competitive molecule may be present in an elution solution at a concentration sufficient to compete off the target molecules from the affinity groups. In some embodiments, the affinity group competitive molecule may be present in an elution solution the amount of 20 millimolar (mM) or greater, 50 mM or greater, 100 mM or greater, 200 mM or greater, 300 mM or greater, 400 mM or greater, or 500 mM or greater. In some embodiments, the affinity group competitive molecule may be present in an elution solution the amount of 1 M or less, 500 mM or less, 400 mM or less, 300 mM or less, 200 mM or less, 100 mM or less, or 50 mM or less. In some embodiments, the affinity group competitive molecule may be present in an elution solution the amount of 20 mM to 400 mM, 50 mM to 200 mM, or 100 mM to 500 mM.

In some embodiments, the elution solution includes high amounts of one or more salts in order to decrease the binding affinity between the target molecule and the affinity groups and/or assistance groups (if present). The salt or mixture of salts may be any salt as described herein, for example, in reference to the isolation solution. The salt or mixture of salts may be present in the elution solution in an amount of 50 millimolar (mM) or greater, 100 mM or greater, 150 mM or greater, 200 mM or greater, 300 mM or greater, 500 mM or greater, or 1 M or greater. The salt or mixture of salts may be present in the elution solution in an amount of 5 M or less, 1 M or less, 500 mM or less, 300 mM or less, 200 mM or less, or 100 mM or less.

In some embodiments, the amount and/or identity of a kosmotrope and/or chaotropic salts may be designed to decrease the binding affinity between the target molecules and the affinity groups and/or assistance group (if present).

In some embodiments, the pH of the elution solution may be such as to decrease the binding affinity between the target molecules and the affinity groups. Without wishing to be bound by theory, the pH of the solution may impact the strength and/or availability of various affinity group-target molecule interactions such as hydrogen bonding interactions, electrostatic interactions, hydrophobic interactions, or any combination thereof. For example, the binding interaction between several epitope tags and affinity groups containing an anti-epitope peptide can be disrupted by using an elution solution that has a neutral or acidic pH. In some embodiments, the pH of the elution solution may be higher than the pH of the washing and/or isolation solution. In some embodiments, the pH of the elution solution may be lower than the pH of the washing and/or isolation solution. In some embodiments, the pH of the elution solution may be the same as than the pH of the washing and/or isolation solution.

The volume of the elution solution used to elute the target may vary. For example, in embodiments where the separation media is being employed to concentrate the target, the volume of elution solution is less that the volume of isolation solution.

In some embodiments, the method includes regenerating the separation media. Regeneration is done to prepare the separation media (or the separation media of a separation device) for subsequent uses. Regeneration may include washing the separation media with a solution designed to strip any molecule that is not covalently attached to the support substrate form the separation media. Regeneration may also include flowing an equilibration solution through the separation media such as to prepare the separation media for future use. In some embodiments, the equilibrium solution may be the same as the isolation solution but without the target molecule or the same as the washing solution.

### Illustrative Embodiments

The technology described herein is defined in the claims. However, below is provided a non-exhaustive listing of non-limiting embodiments. Any one or more of the features of these embodiments may be combined with any one or more features of another example, embodiment, or aspect described herein.

Embodiment 1 is a separation media that includes:
a support substrate; and
a plurality of separation ligands for formula SL1 or SL2

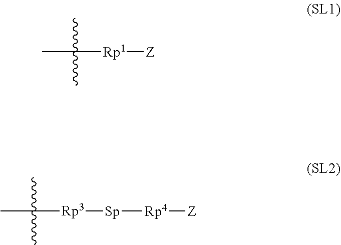

wherein:
Z is a separation group that includes an affinity group, the affinity group comprising a dye capable of binding a biomolecule; and
Rp¹, Rp³, and Rp⁴ each independently including the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, or an isomer thereof

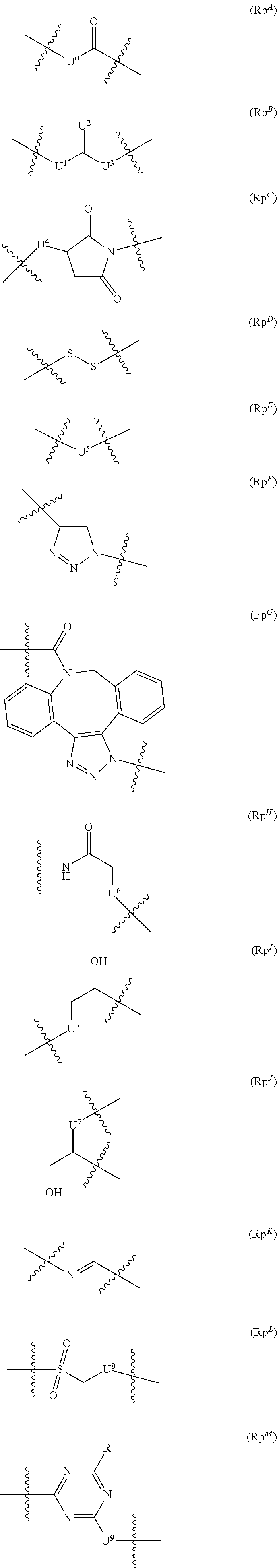

wherein:
U⁰, U¹, U², U³, U⁴, U⁵, U⁶, U⁷, U⁸, and U⁹ are each independently N, NH, O, or S;
R is an organic group, H, or halogen; and
Sp is a spacer including a divalent organic group.

Embodiment 2 is the separation media of Embodiment 1, wherein the plurality of separation ligands are of formula SL2 and Sp is an alkanediyl or alkenediyl that includes one or more catenated functional groups.

Embodiment 3 is the separation media Embodiment 2, wherein the alkanediyl or alkenediyl includes a backbone chain of length C1 to C18.

Embodiment 4 is the separation media of Embodiment 2 or 3, wherein the alkanediyl or alkenediyl includes a backbone chain of length C1 to C3.

Embodiment 5 is the separation media of any of Embodiments 1 through 4, wherein Sp is or includes —C(O)—.

Embodiment 6 is the separation media of any Embodiments 1 through 5, wherein Rp³, Rp⁴, or both include or are Rp^{E}.

Embodiment 7 is the separation media Embodiment 1 or 6, wherein Rp³ and Rp⁴ are or include Rp^{E}.

Embodiment 8 is the separation media of Embodiment 7, wherein each U⁵ is O.

Embodiment 9 is the separation media of Embodiment 7, wherein each U⁵ is NH.

Embodiment 10 is the separation media of Embodiment 7, wherein one U⁵ is NH and the other U⁵ is O.

Embodiment 11 is the separation media of any of Embodiments 1 through 5, wherein SL2 includes or is

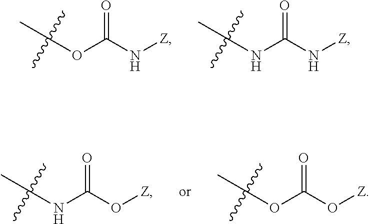

Embodiment 12 is the separation media of any of Embodiments 1 through 4, wherein SL2 includes or is

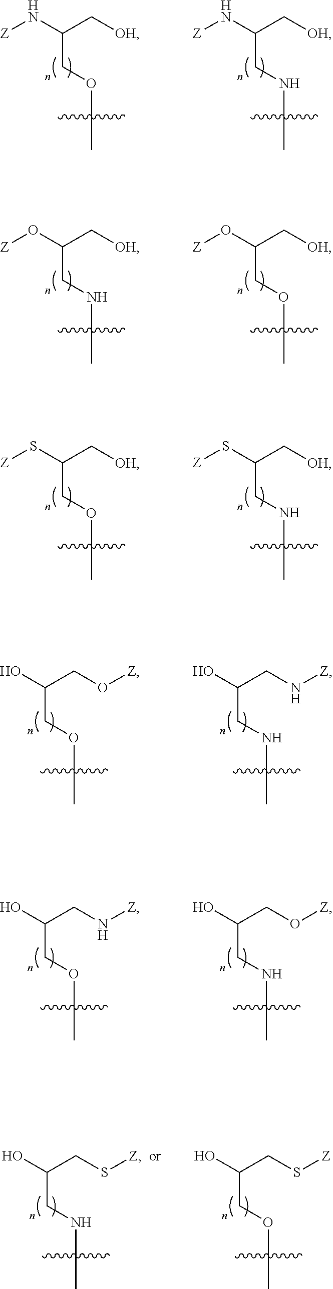

wherein n is 0, 1, 2, 3, 4, 5, 6, 7, 8, 9, or 10.

Embodiment 13 is the separation media of Embodiment 12, wherein n is 1.

Embodiment 14 is the separation media of any of Embodiments 1 through 13, wherein the support substrate includes or is a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

Embodiment 15 is the separation media of any of Embodiments 1 through 14, wherein the separation media is configured for use with an organic solvent.

Embodiment 16 is the separation media of any of Embodiments 1 through 14, wherein the separation media is configured for use with an aqueous solvent.

Embodiment 17 is the separation media of any of Embodiments 1 through 16, wherein the biomolecule is a protein.

Embodiment 18 is the separation media of any of Embodiments 1 through 17, wherein the dye is a triphenylmethane dye, a cyanine dye; an azo dye; or a triazine dye.

Embodiment 19 is the separation media of Embodiment 1 through 17, wherein the biomolecule is dehydrogenase, a kinase, lysozyme, a serum albumin, a nicotinamide adenine dinucleotide dependent protein, a nucleotide binding protein, or any combination thereof and the dye is a triazine dye, an azo dye, or both.

Embodiment 20 is the separation media of any of Embodiments 1 through 16, wherein the biomolecule is an oligonucleotide.

Embodiment 21 is the separation media of Embodiment 20, wherein the oligonucleotide is double stranded, single stranded, or both.

Embodiment 22 is the separation media of claim of any of Embodiments 1 through 21, wherein the dye is a phenanthridine dye, a polymethine dye, a phenylindole dye, or a bisbenzimide dye.

Embodiment 23 is the separation media of any of Embodiments 1 through 22, wherein the dye is a triarylmethane dye or a xanthene dye.

Embodiment 24 is a separation media including two or more of the separation media of any of Embodiments 1 through 23 arranged in a stacked configuration.

Embodiment 25 is the separation media of Embodiment 24, wherein the separation media includes two separation media and the separation media are of the same identity.

Embodiment 26 is the separation media of Embodiment 25, wherein the separation media includes two separation media and the separation media are of a different identity.

Embodiment 27 is a separation device that includes a housing and the separation media of any of Embodiment 1 through 26 disposed within the housing.

Embodiment 28 is a method of isolating a target biomolecule from an isolation solution:
the isolation solution including:
a solvent; and
the target molecule;
the method including:
contacting the isolation solution with the separation media of any of Embodiments 1 through 25.

Embodiment 29 is the method of Embodiment 28, wherein the method further includes washing the separation media with a washing solution.

Embodiment 30 is the method of Embodiment 28 or 29, wherein the method further includes contacting the separation media with an elution solution.

### EXAMPLES

The present disclosure is illustrated by the following examples. It is to be understood that the particular examples, materials, amounts, and procedures are to be interpreted broadly in accordance with the scope and spirit of the disclosure as set forth herein.

### Example 1. Example Synthetic Methods that May be Used to Prepare the Separation Media of the Present Disclosure

Several synthetic strategies may be employed to construct the separation media of the present disclosure. The synthetic strategies include direct or indirect immobilization of separation ligands. The synthetic strategies also include amine assisted coupling and/or organic solvent assisted coupling.

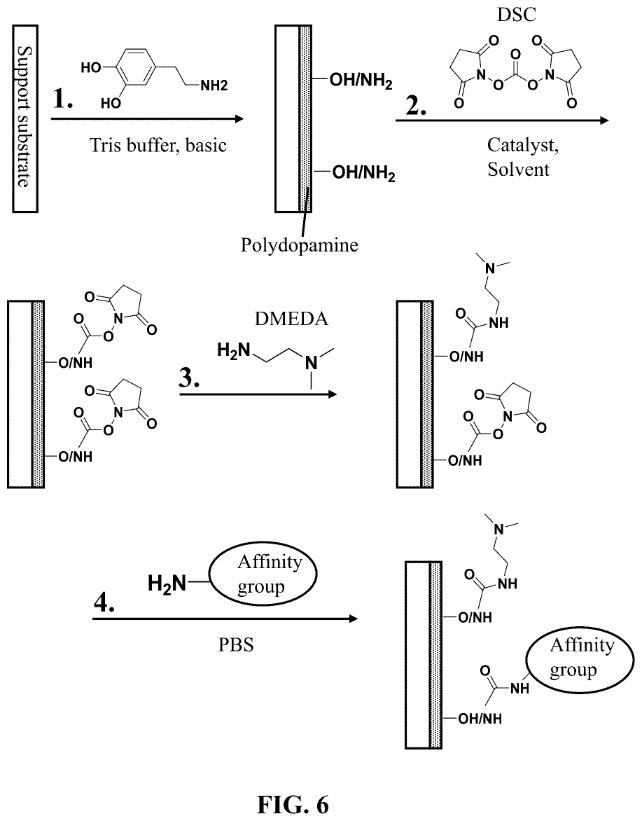

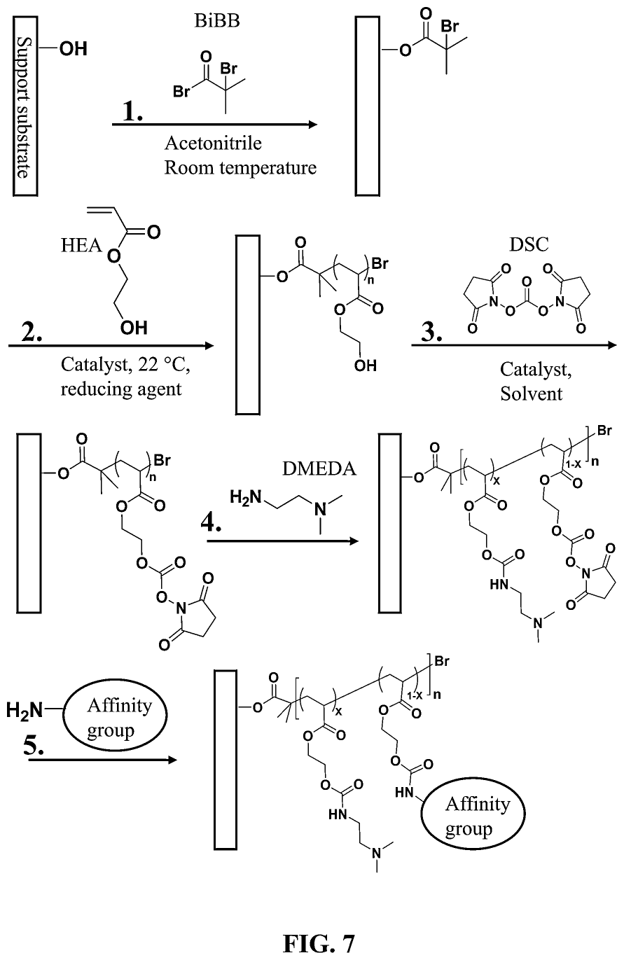

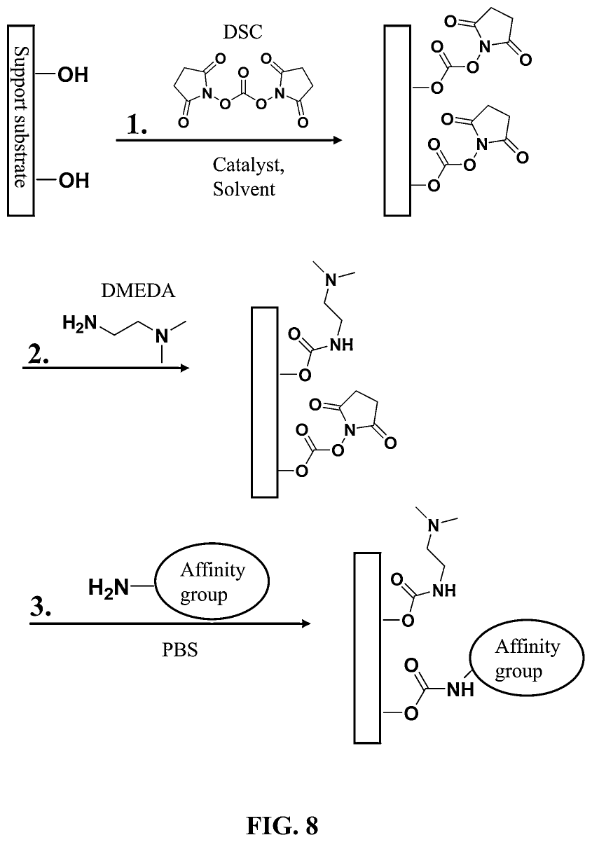

FIG. 6 and FIG. 7 show schematics of synthetic schemes that include the indirect immobilization of the separation ligands to the support substrate. The strategies of FIG. 7 and FIG. 8 also include the amine assisted coupling method.

In step 1, of the scheme in FIG. 6, polydopamine (PDA) is incorporated onto a support substrate through oxidative polymerization of dopamine in basic aqueous buffer in the presence of air. Deposition of PDA may function to hydrophilize the support substrate and introduce support substrate reactive handles (e.g., hydroxyl, amine, and quinone). In step 2, the PDA reactive handles may be reacted with the bifunctional (has two NHS ester reactive handles) of linker precursor disuccinimidyl carbonate (DSC). The PDA reactive handles (OH and NH₂) may react with the first N-hydroxy succinimidyl (NHS) ester of the linker precursor to form a first amide or carbamate reaction product. In step 3, a portion of the second NHS ester groups may be reacted with the primary amine reactive handle of N,N-dimethylethylenediamine (DMEDA; a first separation group precursor) to form a second amide reaction product. The DMEDA groups (e.g., the tertiary amine of DMEDA) may act as an assistance affinity groups to increase the local concentration of negatively charged (in aqueous buffer) affinity groups at the membrane surface through coulombic interaction. In step 4, the second portion of the second NHS ester groups may be reacted with a second separation group (including an affinity group) precursor reactive handle (an amine as shown in this scheme) to form an amide reaction product. The conjugation reaction of step 4 may be done in an aqueous buffer.

In the first step of the scheme depicted in FIG. 7, an initiator (α-bromoisobutyryl bromide, BiBB) may be coupled to the OH groups of a support substrate. In the second step, hydroxyethyl acrylate monomers may be polymerized from the immobilized initiator to from poly(HEA). In step 3, the poly(HEA) reactive handles (OH groups) may be reacted with the bifunctional (has two NHS ester reactive handles) linker precursor disuccinimidyl carbonate (DSC). The poly(HEA) reactive handles (OH) may react with the first NHS ester of the linker precursor to form a first carbamate reaction product. In step 4, a portion of the second NHS ester groups may be reacted with the amine reactive handle of N,N-dimethylethylenediamine (DMEDA; a first separation group precursor) to form an amide reaction product and install the separation ligands containing the amine assistance groups. The DMEDA groups (e.g., the tertiary amine of DMEDA) may act as assistance groups which may allow for a higher density of negatively charged (in aqueous buffer) affinity groups at the support substrate surface through coulombic interaction. In step 5, the second portion of the second NHS ester groups may be reacted with a second separation group (including the affinity group) precursor reactive handle to form an amide reaction product and install the separation ligands containing the affinity group on the support substrate. The conjugation reaction of step 5 may be completed in an aqueous buffer reaction mixture. In some embodiments, the support substrate may be exposed to a tris base solution as a final step to quench unreacted NHS intermediates and to install separation ligands containing a capping group.

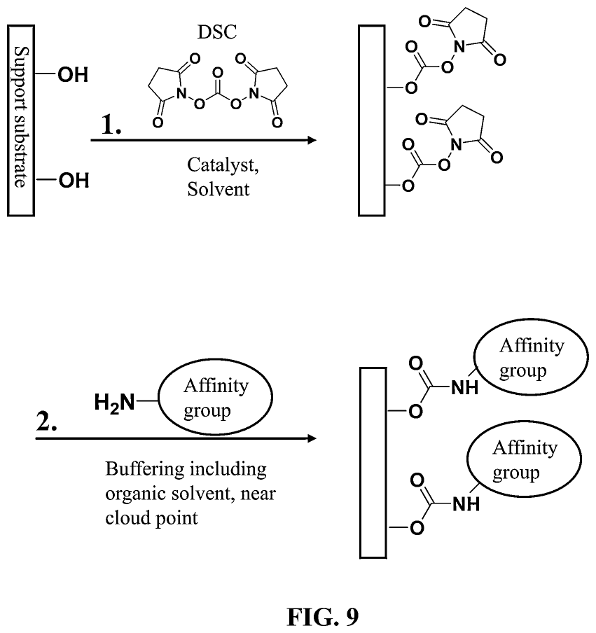

FIG. 8 and FIG. 9 show schematics of synthetic schemes that include the direct immobilization of the separation ligands on the support substrate. The strategies of FIG. 8 includes the amine assisted cooling method. The strategy of FIG. 9 includes the organic solvent assistance method.

FIG. 8 shows a synthetic strategy where the separation ligands can be directly immobilized on the support substrate and the amine assisted method may be used to achieve a high density of separation ligands. This synthetic strategy is similar to the strategy in FIG. 6 except that the membrane was not functionalized with a polymer. Instead, the hydroxyl reactive handles of the support substrate can be directly reacted with one of the NHS ester reactive handles of DSC to form a carbamate reaction product (step 1). Separation ligands having an amine assistance group can be installed (step 2). The amine assistance group may facilitate the installation of the separation groups that include an affinity group (step 3). The conjugation reaction of step 3 may be done in an aqueous buffer reaction mixture.

FIG. 8 shows a synthetic strategy where the separation ligands can be directly immobilized on the support substrate and the organic solvent assisted method may be used to achieve a high density of separation ligands. Residual tertiary amine moieties in the final separation media may have the potential for nonspecific binding when the solution conductivity is very low. As affinity chromatography typically is performed at conductivity levels above that which tertiary amines retain significant binding capacity, the residual amine groups were expected to have negligible effect on chromatographic performance. In an effort to circumvent this potential issue completely, an organic solvent assisted coupling method may be employed to install the separation ligands containing the affinity group. The organic assisted coupling method utilizes water-miscible organic solvents as a constituent of the coupling solution to increase separation group precursor coupling efficiency, which enables use of low separation group precursor concentrations in the coupling solution. Additions of organic solvents to the aqueous buffered reaction mixture (10%-80% by volume depending on the organic solvent used) to bring solution near the cloud point. At the cloud point, the reaction mixture starts to appear turbid upon increasing the concentration of organic solvent. Organic solutions replace water molecules in the separation group precursor solvation shell which can facilitate greater interaction between the separation group precursor and the support substrate. Additional organic solutions added beyond the cloud point may exacerbate aggregation and flocculation dynamics of the separation group precursor, which can comparatively reduce efficiency of coupling reaction. This coupling methodology may allow for high performance separation media to be prepared with low separation group consumption.

FIG. 9 shows an example synthetic scheme that may be used to prepare separation media of the present application via direct immobilization of the separation ligands using the organic solvent assisted coupling method. In step 1 the support substrate reactive handles (OH) may be reacted with the first N-hydroxy succinimidyl (NHS) ester of the DSC linker precursor to form a carbamate reaction product. In the second step, a reaction mixture that is near the cloud point that includes the separation group precursor (includes the affinity group), water, and a water-miscible solvent may be exposed to the reaction product of step 2. The second NHS ester groups of the support substrate-linker conjugate may react with the reactive handle (NH₂) of the separation group precursor to form an amide reaction product and install the separation ligands having the affinity group on the support substrate.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A separation media comprising:
a support substrate; and
a plurality of separation ligands for formula SL1 or SL2 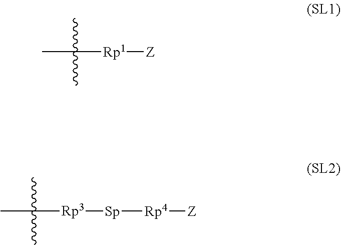
wherein:
Z is a separation group comprising an affinity group, the affinity group comprising a dye capable of binding a biomolecule; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, or an isomer thereof 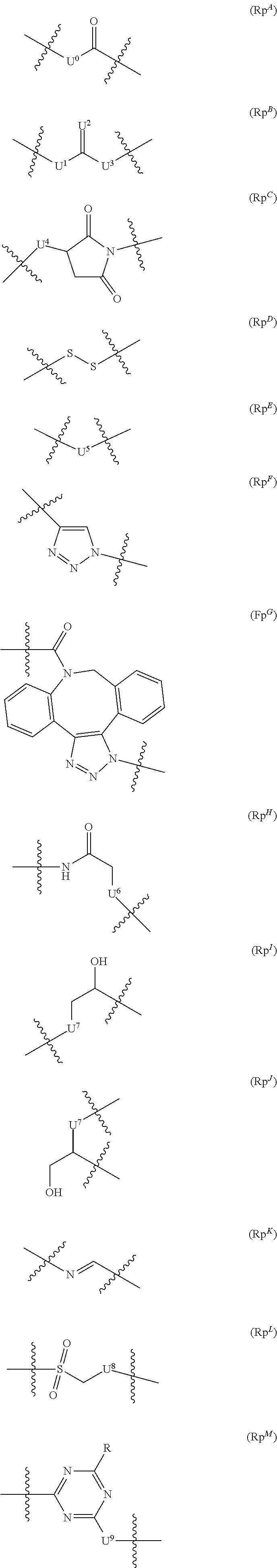
wherein:
U⁰, U¹, U², U³, U⁴, U⁵, U⁶, U⁷, U⁸, and U⁹ are each independently N, NH, O, or S;
R is an organic group, H, or halogen; and
Sp is a spacer comprising a divalent organic group.

2. The separation media of claim 1, wherein the plurality of separation ligands are of formula SL2 and Sp is an alkanediyl or alkenediyl comprising one or more catenated functional groups.

3. The separation media of claim 2, wherein the alkanediyl or alkenediyl comprises a backbone chain of length C1 to C18.

4. The separation media of claim 1, wherein Sp comprising —C(O)—.

5. The separation media of claim 1, wherein Rp³ and Rp⁴ comprises Rp^{E}, and wherein one U⁵ is NH and U⁵ is O.

6. The separation media of claim 1, wherein SL2 comprises

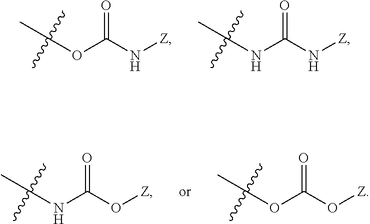

7. The separation media of claim 1, wherein SL2 comprises 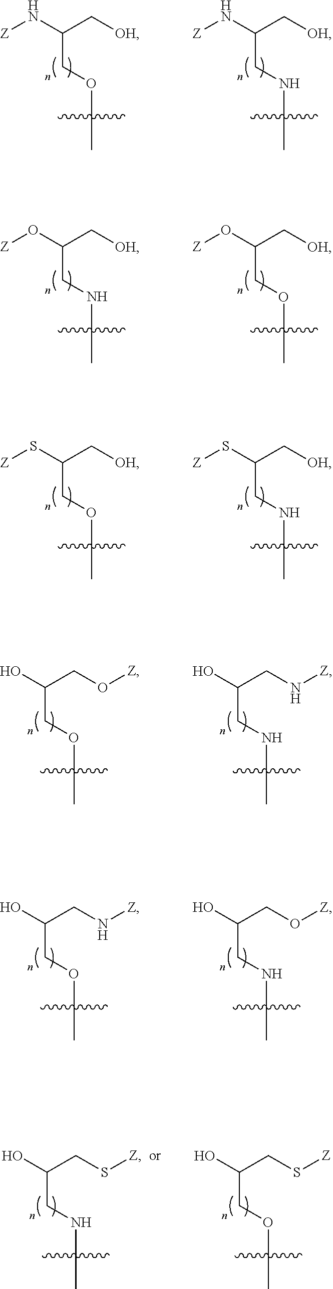
wherein n is 0, 1, 2, 3, 4, 5, 6, 7, 8, 9, or 10.

8. The separation media of claim 1, wherein the support substrate comprises a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

9. The separation media claim 1, wherein the separation media is configured for use with an organic solvent, an aqueous solvent, or both.

10. The separation media of claim 1, wherein the biomolecule is a protein.

11. The separation media of claim 10, wherein the protein is dehydrogenase, a kinase, lysozyme, a serum albumin, a nicotinamide adenine dinucleotide dependent protein, a nucleotide binding protein, or any combination thereof and the dye is a triazine dye, an azo dye, or both.

12. The separation media of claim 1, wherein the biomolecule is an oligonucleotide.

13. The separation media of claim 12, wherein the oligonucleotide is double stranded, single stranded, or both.

14. The separation media of claim 1, wherein the dye is a triphenylmethane dye, a cyanine dye; an azo dye; or a triazine dye.

15. The separation media of claim 1, wherein the dye is a phenanthridine dye, a polymethine dye, a phenylindole dye, or a bisbenzimide dye.

16. The separation media of claim 1, wherein the dye is a triarylmethane dye or a xanthene dye.

17. A separation device comprising a housing and a separation media disposed within the housing, the separation media comprising:
a support substrate; and
a plurality of separation ligands for formula SL1 or SL2 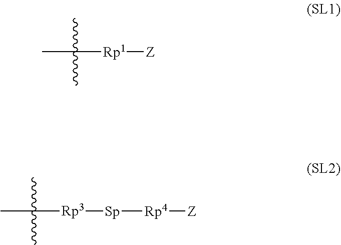
wherein:
Z is a separation group comprising an affinity group, the affinity group comprising a dye capable of binding a biomolecule; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, or an isomer thereof 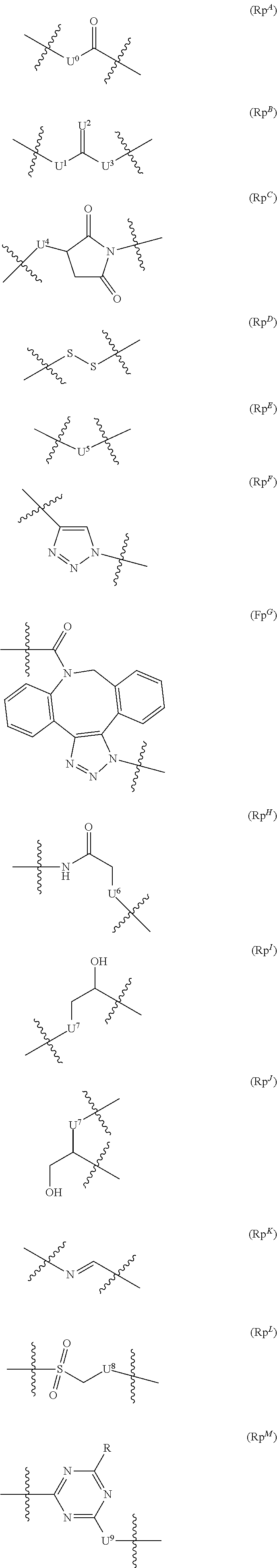
wherein:
U⁰, U¹, U², U³, U⁴, U⁵, U⁶, U⁷, U⁸, and U⁹ are each independently N, NH, O, or S;
R is an organic group, H, or halogen; and
Sp is a spacer comprising a divalent organic group.

18. A method of isolating a target biomolecule from an isolation solution:
the isolation solution comprising:
a solvent; and
the target molecule;
the method comprising:
contacting the isolation solution a separation media, the separation media comprising
a support substrate; and
a plurality of separation ligands for formula SL1 or SL2 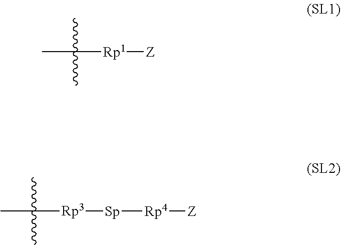
wherein:
Z is a separation group comprising an affinity group, the affinity group comprising a dye capable of binding a biomolecule; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, or an isomer thereof 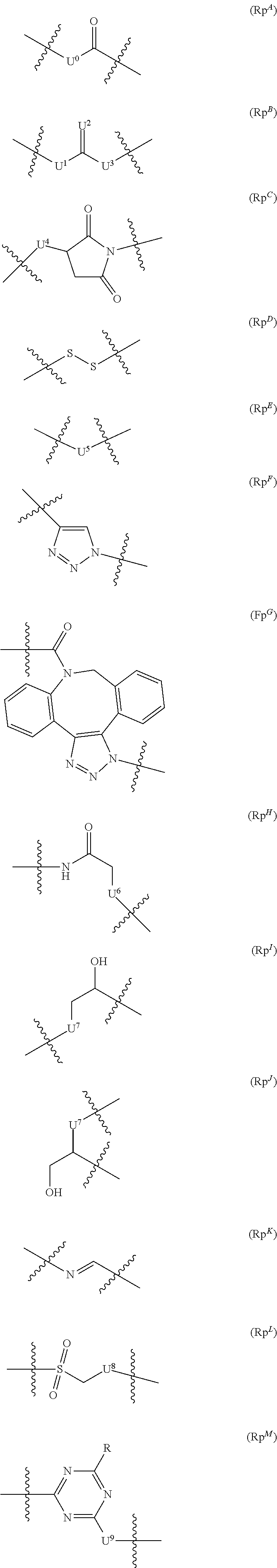
wherein:
U⁰, U¹, U², U³, U⁴, U⁵, U⁶, U⁷, U⁸, and U⁹ are each independently N, NH, O, or S;
R is an organic group, H, or halogen; and
Sp is a spacer comprising a divalent organic group.

19. The method of claim 18, wherein the method further comprises washing the separation media with a washing solution.

20. The method of claim 18, wherein the method further comprises contacting the separation media with an elution solution.
